(19) United States
(12) Patent Application Publication
(10) Pub. No.: US 2026/0242286 A1
(43) Pub. Date: Aug. 20, 2026

(54) CRACKING RESISTANT ASPHALT BINDERS INCLUDING HARD ASPHALT, AND RELATED METHODS

(71) Applicant: Marathon Petroleum Company LP, Findlay, OH (US)

(72) Inventors: Cristian S. Clopotel, Findlay, OH (US); Anas A. Jamrah, Findlay, OH (US); Brian K. Wilt, Findlay, OH (US); Samuel W. Huddleston, Findlay, OH (US); Lora C. Collins, Findlay, OH (US)

(73) Assignee: Marathon Petroleum Company LP, Findlay, OH (US)

(21) Appl. No.: 19/544,718

(22) Filed: Feb. 19, 2026

Related U.S. Application Data
(60) Provisional application No. 63/760,970, filed on Feb. 20, 2025.
(60) Provisional application No. 63/760,996, filed on Feb. 20, 2025.
(60) Provisional application No. 63/760,991, filed on Feb. 20, 2025.
(60) Provisional application No. 63/896,394, filed on Oct. 9, 2025.
(60) Provisional application No. 63/896,416, filed on Oct. 9, 2025.

(51) Int. Cl. C04B 26/26; C04B 40/00; C04B 111/28; C04B 111/34

(52) U.S. Cl. CPC C04B 26/26; C04B 40/0089; C04B 2111/28; C04B 2111/343; C04B 2201/10

(57) ABSTRACT

A method of forming a cracking resistant asphalt binder using at least one hard asphalt includes providing at least one hard asphalt having a penetration between 0 dmm and 10 dmm at about 25° C., a softening point between about 65.6° C. and about 104.4° C., a high temperature compliance of at least about 85° C., and a low temperature compliance greater than about −12° C., and mixing the at least one hard asphalt with a base asphalt material to form a cracking resistant asphalt binder having a performance grade of PG 64-22 and a ΔT_{c} greater than −5° C. after PAV aging for 40 hours, the cracking resistant asphalt binder comprising at least about 5.0 weight percent of the at least one hard asphalt by weight of the base asphalt material. Related cracking resistant asphalt binders and methods are also disclosed.

### CROSS REFERENCE TO RELATED APPLICATIONS

This application claims the benefit of the filing date of U.S. Provisional Patent Application Ser. No. 63/760,970, filed Feb. 20, 2025, for “CRACKING RESISTANT ASPHALT BINDERS INCLUDING HIGH VISCOSITY VACUUM TOWER BOTTOMS MATERIAL AND AT LEAST ONE OF A HEAVY VACUUM GAS OIL OR A BIOMATERIAL, AND RELATED METHODS,” the filing date of U.S. Provisional Patent Application Ser. No. 63/760,991, filed Feb. 20, 2025, for “CRACKING RESISTANT ASPHALT BINDERS INCLUDING BIO-RESINS, AND RELATED METHODS,” the filing date of U.S. Provisional Patent Application Ser. No. 63/760,996, filed Feb. 20, 2025, for “CRACKING RESISTANT ASPHALT BINDERS INCLUDING HARD ASPHALT, AND RELATED METHODS,” the filing date of U.S. Provisional Patent Application Ser. No. 63/896,394, filed Oct. 9, 2025, for “CRACKING RESISTANT ASPHALT BINDERS INCLUDING BLEND OF LOW VISCOSITY VACUUM TOWER BOTTOMS AND BIO-RESINS, AND RELATED METHODS,” and the filing date of U.S. Provisional Patent Application No. 63/896,416, filed Oct. 9, 2025, for “MOISTURE RESISTANT ASPHALT MIXTURES INCLUDING BLEND OF LOW VISCOSITY VACUUM TOWER BOTTOMS, BIOMATERIALS, AND HARD ASPHALT, AND RELATED METHODS,” the entire disclosure of each of which applications is incorporated herein in its entirety by this reference.

### BACKGROUND

Asphalt binder, also known as bitumen, is a sticky, black, and viscous material. Asphalt may be obtained from natural deposits or may be obtained as a product of crude oil refining. Asphalt is a natural constituent of crude oil, which may include, among other things, paraffinic materials, naphthenes, aromatics, and asphaltenes. Generally, the components of different materials in crude oil are separated by distillation into various fractions. After separation, these fractions are further refined into other products such as gasoline, naphtha, lubricating oil, kerosene, diesel oil, and asphalt. Asphalt binder is the heavy constituent of crude petroleum, and typically forms the residue that remains after the oil refining process.

Asphalt binder may be sold and used as a binder to bind mineral aggregates in asphalt concrete. Asphalt concrete, also referred to as blacktop or pavement, is a composite material used to surface roads and parking lots. Conventional asphalt concrete suffers from different types of distress modes, including permanent deformation. For example, asphalt concrete can deform to cause a depression or groove in the driving surface, also known as rutting. Rutting may prevent the designed removal of rainwater from road surfaces, which can lead to pooling of water on the road surfaces. Asphalt cement exhibiting a high degree of stiffness can mitigate against rutting. Solvent deasphalting (SDA) pitch is a hard, brittle material that has also been used to modify asphalt binders to increase resistance to rutting. Increasing the stiffness of the asphalt binder generally negatively affects the low temperature properties of the asphalt binder, such as by causing the asphalt binder to be more susceptible to thermal or fatigue cracking at intermediate and low temperatures (and increasing the low temperature compliance (e.g., increasing the temperature of the low temperature compliance) of the asphalt binder).

Superior Performance Asphalt Pavement (Superpave) Performance Grade (PG) asphalt binder was introduced in the past in an effort to improve asphalt properties. PG asphalt is specified by the American State Association of State Highway and Transportation Officials (AASHTO). AASHTO M320 is a standard specification developed by the AASHTO for performance graded asphalts. The objective of Superpave and performance graded asphalt specifications is to address permanent deformation (e.g., rutting), fatigue cracking, and low temperature thermal cracking. To address these issues, new equipment was introduced to test the properties of the asphalt binders that affect or correlate to performant deformation, fatigue cracking, and/or low temperature thermal cracking. For example, a dynamic shear rheometer (DSR) may be used to characterize asphalt binder properties at high and intermediate temperatures; and a bending beam rheometer (BBR) and direct tension (DT) device may be used to characterize asphalt binder properties at low temperatures.

The asphalt binder may be aged prior to testing to characterize the performance of the asphalt binder responsive to aging. Methods of aging the asphalt binder include rolling thin film oven (RTFO) aging and pressure aging vessel (PAV) aging. Many performance tests are performed on asphalt binders after RTFO aging or PAV aging for 20 hours or 40 hours. G/sin(δ) was introduced to characterize the unaged and RTFO aged asphalts. In addition, G*sin(δ) on asphalt binders aged for 20 hours in a PAV (20-hour PAV-aged asphalt binder) was introduced to characterize the asphalt binder at intermediate temperatures. Stiffness and m-value, measured in the BBR, were introduced to address thermal cracking.

Although significant improvements were noted after introduction of G*sin(δ), there are several shortcomings in the proposed specification, and the current criteria for thermal cracking is not reliable. The National Cooperative Highway Research Program (NCHRP) 09-59 was initiated to find a better parameter that correlates the fatigue properties of the asphalt binder to the fatigue performance of an asphalt blend. To further address thermal cracking, Delta T_{c} (ΔT_{c}) was introduced by the Airfield Asphalt Pavement Technology Program (AAPTP), Project 06-01 “Techniques for Prevention and Remediation of Non-Load-Related Distresses on HMA Airport Pavements.” The ΔT_{c} is an indicator of how effectively the asphalt binder responds to aging. The ΔT_{c} corresponds to the difference in the critical low temperature values of the asphalt binder according to the Superpave performance grading methodology. The ΔT_{c} is calculated by subtracting the BBR s-critical temperature at 60 seconds of loading (Tc, m(60 s)), which is the resulting temperature when the S-value is exactly equal to the specification value of 300 MPa, from the BBR m-critical temperature at 60 seconds of loading (Tc, S(60 s)), which is the resulting temperature when the m-value is exactly equal to the specification value of 0.300. The creep stiffness of the asphalt binder represents the ability of the asphalt binder to resist deformation under constant load. The Federal Highway Association (FHWA)-ICT-21-015 Rheology-Chemical Based Procedure to Evaluate Additives/Modifiers Used in Asphalt Binders for Performance Enhancements: Phase 2″ suggests a minimum of −5° C. for the ΔT_{c} for an asphalt binder aged in the PAV for 40 hours.

### BRIEF SUMMARY

In some embodiments, a method of forming a cracking resistant asphalt binder using at least one hard asphalt includes providing at least one hard asphalt having a penetration between 0 dmm and 10 dmm at about 25° C., a softening point between about 65.6° C. and about 104.4° C., a high temperature compliance of at least about 85° C., and a low temperature compliance greater than about −12° C., and mixing the at least one hard asphalt with a base asphalt material to form a cracking resistant asphalt binder having a performance grade of PG 64-22 and a ΔT_{c} greater than −5° C. after PAV aging for 40 hours, the cracking resistant asphalt binder comprising at least about 5.0 weight percent of the at least one hard asphalt by weight of the base asphalt material.

In some embodiments, a cracking resistant asphalt binder includes a base asphalt material having a performance grade of PG 58-28, and at least about 5.0 parts by weight of at least one of solvent deasphalting pitch or propane deasphalting pitch for every about 100.0 parts by weight of the base asphalt material, the at least one of the solvent deasphalting pitch or the propane deasphalting pitch having a penetration between 0 dmm and 10 dmm at about 25° C., a softening point between about 65.6° C. and about 104.4° C., a high temperature compliance of at least about 85° C., and a low temperature compliance greater than about −12° C., wherein the cracking resistant asphalt binder has a performance grade of PG 64-22 and a ΔT_{c} greater than −5° C. after PAV aging for 40 hours.

In some embodiments, a method of forming a cracking resistant asphalt binder using at least one hard asphalt includes providing a hard asphalt comprising at least one of solvent deasphalting pitch or propane deasphalting pitch, the hard asphalt having a viscosity of at least about 1,000,000 P at about 60° C. and a high temperature compliance of at least about 85° C., and mixing the at least one hard asphalt with a base asphalt material to form a cracking resistant asphalt binder having a ΔT_{c} greater than −5° C. after PAV aging for 40 hours, the cracking resistant asphalt binder comprising at least about 5.0 weight percent of the at least one hard asphalt by weight of the base asphalt material.

In some embodiments, a cracking resistant asphalt binder includes a base asphalt material comprising at least about 40.0 weight percent of heavy vacuum tower bottoms having a vacuum viscosity greater than about 60,000 P, a high temperature compliance of at least about 85° C., and a low temperature compliance between about 0° C. and about −9° C. after PAV aging for 20 hours, and from about 5.0 parts by weight to about 45.0 parts by weight of hard asphalt comprising at least one of solvent deasphalting pitch or propane deasphalting pitch for every about 100.0 parts by weight of the base asphalt material, the hard asphalt having a viscosity of at least about 1,000,000 P at about 60° C. and a high temperature compliance of at least about 85° C. The cracking resistant asphalt binder has a ΔT_{c} greater than −5° C. after PAV aging for 40 hours.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a simplified schematic of a system for forming a hard asphalt that may be used to blend with a base asphalt material to form a blended asphalt binder comprising a cracking resistant asphalt binder, according to at least one embodiment of the disclosure;

FIG. 2 is a simplified schematic of a system for forming a hard asphalt that may be used to blend with a base asphalt material to form a blended asphalt binder comprising a cracking resistant asphalt binder, according to at least one embodiment of the disclosure;

FIG. 3 is a simplified flow diagram illustrating a system for forming a cracking resistant asphalt binder, according to at least one embodiment of the disclosure;

FIG. 4 is a simplified flow diagram illustrating a system for forming a cracking resistant asphalt binder, according to at least one embodiment of the disclosure;

FIG. 5 is a simplified flow diagram illustrating a method of forming a cracking resistant asphalt binder, according to at least one embodiment of the disclosure;

FIG. 6 is a graph illustrating the high temperature compliance of the base asphalt materials to the high temperature compliance of the cracking resistant asphalt binders including propane deasphalting pitch;

FIG. 7 is a graph illustrating the effect of the propane deasphalting pitch on the ΔT_{c} after PAV aging for 40 hours for each of the base asphalt materials of FIG. 6;

FIG. 8 is a graph illustrating the high temperature compliance of the base asphalt materials to the high temperature compliance of the cracking resistant asphalt binders including solvent deasphalting pitch;

FIG. 9 is a graph illustrating the effect of the solvent deasphalting pitch on the ΔT_{c} after PAV aging for 40 hours for each of the base asphalt materials of FIG. 8;

FIG. 10 is a graph illustrating the distillation curve of the high viscosity vacuum tower bottoms material; and

FIG. 11 is a graph illustrating the distillation curve of the low viscosity vacuum tower bottoms material.

### DETAILED DESCRIPTION

Various equipment and tests may be used to characterize the properties of the asphalt binders described herein. For example, a dynamic shear rheometer (DSR) may be used to characterize asphalt binder properties at high and intermediate temperatures. The DSR is also known as an “oscillator shear rheometer” and is used to measure the rheological properties of liquid asphalt binders at intermediate temperatures (e.g., about 20° C.) to high temperatures (e.g., about 64° C.). The DSR applies a shear stress (τ) and/or a shear strain (γ) to an asphalt binder. The complex shear modulus (G*) is a ratio of the applied shear stress to the resulting shear strain and corresponds to a measure of the total deformation (measured in, for example, kPa). The phase angle (δ) is related to the time lag between the input and output signals and provides a relative indication of the viscous and elastic behavior of the asphalt binder (and represents the ratio of elastic to viscous behavior, measured in degrees). Materials with a phase angle of 90° are completely viscous while materials with a phase angle of 0° are completely elastic. At intermediate temperatures, asphalt binders are generally viscoelastic (with a phase angle of about) 45°.

A bending beam rheometer (BBR) and a direct tension (DT) device may be used to characterize the asphalt binder properties at low temperatures. For example, a BBR may be used to measure the rheological properties of liquid asphalt binders at low temperatures (e.g., about-12° C. or at different temperatures depending on the specification). A fixed static load is applied to an asphalt binder beam of known dimensions, and the resulting deflection is measured. The flexural stiffness is reported as a function of time to provide an indication of the low temperature stiffness and cracking potential of the asphalt binder.

Methods of aging an asphalt binder prior to various tests include rolling thin film oven (RTFO) aging and pressure aging vessel (PAV) aging. Rolling thin film oven simulates the aging (e.g., short-term aging) that occurs in a hot mix asphalt (HMA) facility as thin films of binder are exposed to heat and air. A sample is poured into a cylindrical bottle and rotated horizontally at about 163° C. (about 325° F.). Because RFTO-aged asphalt exhibits a stiffness higher than the stiffness of the unaged asphalt binder, the stiffness of the RFTO-aged asphalt binder is measured to determine whether the desirable viscoelastic properties of the asphalt binder have been maintained after aging. PAV aging methods are designed to simulate oxidation of the asphalt binder over the service life of pavement including the asphalt binder. In PAV methods, the asphalt binders are exposed to high temperature (e.g., about 100° C.) and air pressure (e.g., about 2.10 MPa) for 20 hours (or 40 hours) to simulate long-term aging.

The creep stiffness (S-value, or more simply, S) is a measure of the thermal stresses in the asphalt binder resulting from thermal contraction. If the thermal stresses are too high, cracking will occur. Higher S-values correspond to higher thermal stresses (and a higher likelihood of thermal cracking). The creep stiffness is calculated according to Equation (1) below:

$$S ( t ) = \frac{{PL}^{3}}{4 {bh}^{3} δ ( t )} ; , \qquad ( 1 )$$

wherein P is the applied load in Newtons, L is the span length between the two supports (e.g., 102 mm), b is the beam width (e.g., 12.5 mm), h is the beam thickness (e.g., 6.25 mm), and δ(t) is the deflection (in mm) as a function of time.

The m-value of an asphalt binder represents the rate of change of the stiffness (e.g., the creep stiffness) of the asphalt binder with time and may be representative of the ability of the asphalt binder to relax stresses that develop due to thermal contraction. Determination of the m-value may include aging the asphalt binder in a PAV for a duration, such as for 20 hours or 40 hours. After aging, a beam is prepared from the 20-hour or 40-hour PAV aged asphalt binder. The beam may have, for example, a thickness of about 6.25 mm, a width of about 12.5 mm, and a length of about 125 mm. The beam sample may be tested using a BBR. For example, the beam may be submerged in a temperature-controlled fluid bath having a temperature, such as, for example, −10° C. or about −40° C., depending on the specification. A constant load (e.g., about 100 g (about 980 mN)) is applied to the midpoint of the beam for a specified time (e.g., about 60 seconds, about 240 seconds). The beam may be supported on, for example, stainless steel cylindrical bearings spaced about 102 mm apart, as specified in ASTM D6648 and AASHTO T313 standards. The deflection of the beam responsive to the load is measured as a function of time using a high-precision displacement transducer. The m-value is calculated as the slope of the logarithm of the stiffness curve versus the logarithm of time at the specified time (e.g., about 60 seconds, about 240 seconds). The m-value is shown in Equation (2) below:

$$m ( t ) = \frac{d log S ( t )}{d log ( t )} ; , \qquad ( 2 )$$

wherein S is the creep stiffness of the asphalt binder at a given temperature, t is the loading time (typically measured at 60 seconds), and d represents the derivative operator (the rate of change) of the respective parameter (e.g., the creep stiffness, time). According to Equation (2), the m-value corresponds to how quickly the creep stiffness changes over time. In other words, the m-value is the rate at which the material relaxes stress under a constant load, wherein higher m-values correspond to better stress relaxation and lower susceptibility to thermal cracking.

The ΔT_{c} may correspond to the degree of embrittlement of the asphalt binder and may be calculated according to Equation (3) below:

$$Δ {T}_{c} = {T}_{{c}_{s} -} {T}_{{c}_{m}} ; , \qquad ( 3 )$$

wherein T_{Cm} is the temperature at which the m-value equals 0.300 (referred to as the critical temperature for the m-value) and T_{Cs} is the temperature at which the creep stiffness equals 300 MPa (referred to as the critical temperature for the creep stiffness). A negative ΔT_{c} value below −5° C. may indicate or suggest embrittlement and reduced durability of the asphalt binder compared to asphalt binders having a relatively higher (less negative) ΔT_{c} value.

As used herein, a high temperature compliance (HTC) of an asphalt binder is the temperature at which the unaged DSR tested sample and the RFTO tested sample fails specifications of G*/sin(δ) equal to −1.0 kPa for the original unaged binder and/or G*/sin(δ) equal to 2.2 kPa after RTFO. The high temperature compliance represents the highest temperature at which the asphalt binder can resist rutting or deformation under load. The unaged and RFTO-aged asphalt binder are individually placed between parallel plates spaced by about 1 mm in a DSR, and one of the plates (e.g., the upper plate) oscillates to apply a sinusoidal shear stress or shear strain on the asphalt binder. The temperature is selected depending on the performance grade of the asphalt binder and is usually varied in 6° C. increments (e.g., 46° C., 52° C., 58° C., 64° C., 70° C., 76° C.). The DSR measures the resistance of the binder to shear deformation and determines the complex shear modulus (G*) and the phase angle (δ). One parameter for high temperature compliance is the value of G* divided by the sin(δ). Unaged asphalt binders having a G*/sin(δ) value greater than or equal to 1.0 meet Superpave PG specifications; and RFTO-aged binders having a G*/sin(δ) value greater than or equal to 2.2 meet Superpave PG specifications. The high temperature compliance for the unaged and RTFO aged asphalt binder can be interpolated according to Equation (4.1) and Equation (4.2), respectively, below:

$${T}_{HTC ( unaged )} = {T}_{low} + \frac{( log ( 1. ) + log ( {G}_{low}^{*} ) )}{( log ( {G}_{high}^{*} ) - log ( {G}_{low}^{*} )} \times ( {T}_{high} - {T}_{low} ) ; , \qquad ( 4.1 )$$

$${T}_{HTC ( unaged )} = {T}_{low} + \frac{( log ( 2.2 ) + log ( {G}_{low}^{*} ) )}{( log ( {G}_{high}^{*} ) - log ( {G}_{low}^{*} )} \times ( {T}_{high} - {T}_{low} ) ; , \qquad ( 4.2 )$$

wherein T_{HTC} is the high temperature compliance in ° C. for the unaged and RTFO aged asphalt binders; T_{low} is the last temperature where the value of G*/sin(δ) was greater than or equal to 1.0 kPa for the unaged asphalt binder or 2.2 kPa for the RTFO aged asphalt binder; T_{high} is the first temperature where the value of G*/sin(δ) was less than 1.0 kPa for the unaged asphalt binder or 2.2 kPa for the RTFO aged asphalt binder; G low is the value of G*/sin(δ) at T_{low}; and G high is the value of G*/sin(δ) at T_{high}. The lower temperature between the temperature at which the value of G*/sin(δ) of the unaged asphalt binder equals 1.0 kPa and the temperature at which the value of G*/sin(δ) of the RTFO aged asphalt binder equals 2.2 kPa.

As used herein, a low temperature compliance (LTC) of an asphalt binder is the temperature at which the creep stiffness or the m-value of the asphalt binder fails specifications. The low temperature compliance represents the lowest temperature at which the binder can resist thermal cracking caused by cold weather stresses. The creep stiffness and the m-value of a PAV-aged asphalt binder may be measured. To have a low temperature compliance at a particular temperature, the creep stiffness of the asphalt binder after 60 seconds (S(60 s)) at the temperature must be less than or equal to 300 MPa and the m-value after 60 seconds (m(60 s)) at the temperature must be greater than or equal to 0.300. If the S(60 s) value exceeds 300 MPa or the m(60 s) value falls below 0.300, the asphalt binder fails and is not compliant at the temperature. The low temperature compliance temperature may be interpolated according to Equation (5) or Equation (6) below:

$${T}_{LTC ( S )} = {T}_{low} + \frac{( log ( 300 ) - log ( {S}_{low} ) )}{( log ( {S}_{high} ) - log ( {S}_{low} ) )} \times ( {T}_{high} - {T}_{low} ) ; \qquad ( 5 )$$

$${T}_{LTC ( m - value )} = {T}_{low} + \frac{( 0.3 - {m}_{low} )}{( {m}_{high} - {m}_{low} )} \times ( {T}_{high} - {T}_{low} ) ; . \qquad ( 6 )$$

wherein T_{low} is the last temperature where S(60 s) was less than or equal to 300 MPa; T_{high} is the first temperature where S(60 s) was greater than 300 MPa; Slow is the creep stiffness at T_{low}; and S_{high} is the creep stiffness at T_{high}; m_{low} is the m-value at T_{low}; and m_{high} is the m-value at T_{high}.

As used herein, a usable temperature range (UTR) of an asphalt binder is the difference between the high temperature compliance and the low temperature compliance of the asphalt binder. The usable temperature range is an indication of the span over which the asphalt binder performs as specified. A larger usable temperature range is an indication of better performance of the asphalt binder across various temperatures. The LTC may be the higher temperature of the T_{LTC(S)} and the T_{LTC (m-value)}.

As used herein, a performance graded asphalt binder is an asphalt binder exhibiting a specified high temperature compliance and a low temperature compliance. As one example, a performance graded asphalt binder having a performance grade of PG 64-22 is an asphalt binder having a high temperature compliance of 64° C. and a low temperature compliance of −22° C. The performance grade of the asphalt binder may also provide an indication of the usable temperature range of the asphalt binder. For example, a PG 64-22 asphalt binder may have a usable temperature range of 86° C. (e.g., 64° C.-(−22° C.)=86° C.).

In some embodiments, a composition of a material (e.g., an asphalt material, a vacuum gas oil, a vacuum tower bottoms material) may be determined according to the IP 469 Standard, “Determination of saturate, aromatic and polar components in petroleum products by thin layer chromatography and flame ionization detection”. A SARA (saturates, aromatics, reins, asphaltenes) analysis may be performed with, for example, the Iatroscan MK-6 thin layer chromatograph, manufactured by Mitsubishi Chemical Medience Corporation, of Japan. The IATROSCAN is an automatic detector that performs quantitative analysis on organic mixtures separated on thin layer chromatography (TLC) and detected by Hydrogen Frame Ionization System (FID). The separation of components is performed on an exclusive thin layer chromatography media (CHROMAROD) in the same manner of normal phase TLC. The IP 469 Standard outlines a methodology for conducting a SARA analysis of the material and may be used to quantify the composition of the different components (saturates, aromatics, resins, and asphaltenes) (also referred to as “fractions”) in the material.

The different components are separated based on solubility using toluene, heptane (or n-pentane), dichloromethane, and methanol. The saturates include non-polar hydrocarbons including alkanes and cycloalkanes; the aromatics include compounds with one or more aromatic rings; the resins include polar, non-asphaltene hydrocarbons; and the aromatics include highly polar, high molecular weight hydrocarbons that are insoluble in n-heptane (or n-pentane). Saturates elute using heptane, aromatics elute using a mixture of 80:20 toluene: heptane by volume, resins elute using a mixture of 95:5 dichloromethane:methanol by volume, while asphaltenes do not elute. Other methods of performing a SARA analysis include using n-heptane (or n-pentane) to precipitate asphaltenes from the sample, while the remaining soluble material (referred to as “maltenes”) is further fractionated using a chromatography column. In the chromatography column, a silica or alumina column is employed to separate the maltenes into saturates, aromatics, and resins using specific solvents of varying polarity. The column is loaded with the maltene solution (the heptane-soluble portion). The saturates are separated from the maltenes by elution using a non-polar solvent, such as n-hexane or heptane; followed by separation of the aromatics by elution using an aromatic-rich solvent, such as toluene or benzene. Finally, the resins are separated by elution using a polar solvent, such as dichloromethane (DCM), acetone, or methanol. Of course, methods of performing a SARA analysis other than that described are possible. For example, the asphaltenes may not be precipitated from the material prior to fractionating the sample in the chromatography column.

This disclosure generally relates to performance graded cracking resistant asphalt binders formed to include one or more hard asphalts, and to systems and methods for preparing the performance graded cracking resistant asphalt binder from a base asphalt material and the one or more hard asphalts to improve the thermal cracking resistance of the base asphalt material. The hard asphalts may include at least one of a solvent deasphalting (SDA) asphalt (SDA pitch) or a propane deasphalting (PDA) asphalt (e.g., PDA pitch). As used herein SDA pitch may also be referred to as “SDA bottoms” and PDA pitch may also be referred to as “PDA bottoms.” The thermal cracking resistance of the asphalt binder may be measured by a 40-hour PAV ΔT_{c} test. In some embodiments, the asphalt binder may exhibit a ΔT_{c} value greater (higher, less negative) than −5° C. after aging for 40 hours in a PAV. Surprisingly, the combination of a predetermined amount of the hard asphalt with the base asphalt material to form the asphalt binder facilitates forming the asphalt binder to exhibit desirable properties within the PG specifications. For example, the presence of the hard asphalt in the asphalt binder may one or more of increase the high temperature compliance of the asphalt binder compared to an asphalt binder having the same composition but without the hard asphalt (e.g., compared to the base asphalt material); increase (make less negative) the ΔT_{c} value of 40-hour PAV-aged asphalt binder (improving the low temperature properties of the cracking resistant asphalt binder); increase the usable temperature range of the asphalt binder; or improve one or more other properties of the asphalt binder. In some embodiments, the presence of the hard asphalt in the asphalt binder may make a PG 64-22 asphalt binder from a base asphalt material having a performance grade of PG 58-28 while still meeting the low temperature specification for a ΔT_{c} value higher than −5° C. after 40-hour PAV aging. The hard asphalt may constitute at least about 5.0 weight percent of the asphalt binder, such as at least about 10.0 weight percent, or at least about 15.0 weight percent of the asphalt binder. In some embodiments, the asphalt binder includes at least about 5.0 parts by weight of the hard asphalt for every about 100.0 parts by weight of the base asphalt material.

The base asphalt material may include a straight asphalt obtained from the distillation of crude oils, a refinery blended asphalt, or a combination thereof. The refinery blended asphalt may include a high viscosity vacuum tower bottoms material and one or more of a high vacuum gas oil, a medium vacuum gas oil, a low vacuum gas oil, a light vacuum tower bottoms material, asphalt pitch, or deasphalted oil. The straight asphalt may include an asphalt binder produced directly from the distillation of crude oil without addition of modifiers, polymers, or other additives (such as, for example, phosphoric acid). In some embodiments, the base asphalt material exhibits a performance grade of about PG 58-28. In some embodiments, the base asphalt material includes at least about 60.0 weight percent of the high viscosity vacuum tower bottoms material. The high viscosity vacuum tower bottoms material may exhibit a vacuum viscosity at about 60° C. higher than about 50,000 P, such as higher than about 60,000 P. In some embodiments, the high viscosity vacuum tower bottoms material is substantially stiff and does not substantially flow at room temperature (e.g., between about 20° C. and about 25° C.).

The hard asphalt may exhibit one or more of (e.g., each of) a penetration between 0.0 dmm and 10.0 dmm at 25° C.; a softening within a range of from 65.6° C. (150° F.) to 104.4° C. (220° F.); a high temperature compliance of at least 85° C.; and a low temperature compliance greater than −12° C. In some embodiments, the hard asphalt exhibits a vacuum viscosity greater (higher) than about 500,000 P, such as greater than about 750,000 P, or even greater than about 1,000,000 P at about 60° C. In some embodiments, the vacuum viscosity of the hard asphalt is higher than the vacuum viscosity of the asphalt binder and/or the high viscosity vacuum tower bottoms material at about 60° C. Surprisingly, mixing the hard asphalt with the base asphalt material forms a cracking resistant asphalt binder having a ΔT_{c} value greater than −5° C., even though hard asphalts generally lower the low temperature compliance of asphalt binders, such as by lowering the ΔT_{c} temperature of PAV aged binders having hard asphalts. The hard asphalt may improve the ΔT_{c} value of the base asphalt material. In other words, the ΔT_{c} value of the asphalt binder including the base asphalt material and the hard asphalt may be higher than the ΔT_{c} value of the base asphalt material, even though the hard asphalt has a higher vacuum viscosity than the base asphalt material. The quality of base asphalt materials from refineries may vary based on operating conditions of the refinery (e.g., the operation of the atmospheric distillation tower, the operation of the vacuum distillation tower) and the composition and assay of the crude oils. For example, some refineries may not consistently form an asphalt binder material or a blended asphalt binder meeting 40-hour PAV-aged ΔT_{c} requirements (e.g., a ΔT_{c} greater than −5° C. after 40 hours of aging in a PAV). Mixing the hard asphalt with the base asphalt material may provide a method for forming an asphalt binder having a ΔT_{c} greater than −5° C. after 40 hours of aging in a PAV without changing the composition of the crude oil or the operating conditions of the atmospheric distillation tower and/or the vacuum distillation tower.

The hard asphalt may exhibit properties such that the cracking resistant asphalt binder including the hard asphalt and the base asphalt material exhibits desirable properties. In some embodiments, the method of forming the hard asphalt affects the properties (e.g., the high temperature compliance, the viscosity, the penetration, the low temperature compliance, the softening point) of the hard asphalt. In some embodiments, the hard asphalt includes at least 20.0 weight percent aromatics. The hard asphalt may include at least about 10.0 weight percent asphaltenes. In some embodiments, the hard asphalt includes at least 1.0 part by weight resin (e.g., at least about 6.0 parts by weight resin) for every about 1.0 part by weight of aromatics. In some embodiments, the hard asphalt includes a mixture of saturates, aromatics, resins, and asphaltenes. The hard asphalt may exhibit synergistic properties with the base asphalt binder. The addition of the hard asphalt having the composition and properties (e.g., the penetration, softening point, high temperature compliance, vacuum viscosity at 60° C.) described herein to the base asphalt binder may improve both the high temperature properties (such as the high temperature compliance) and the low temperature properties (such as the ΔT_{c} after aging) of the base asphalt binder. For example, adding the hard asphalt to the base asphalt binder may surprisingly improve the low temperature properties, such as the ΔT_{c} after 20 hour and after 40-hour PAV aging, even though the hard asphalt may have a vacuum viscosity at about 60° C. higher than the vacuum viscosity of the base asphalt binder. In addition, the hard asphalt, when added to the base asphalt binder, may improve the high temperature compliance of the base asphalt binder such that the cracking resistant asphalt binder exhibits a higher high temperature compliance than the base asphalt binder. In some embodiments, the addition of the hard asphalt to a base asphalt binder may facilitate forming a cracking resistant asphalt binder having a performance grade of PG 64-22 and a ΔT_{c} higher than −5° C. after 20 hour and after 40-hour PAV aging from a base asphalt binder having a performance grade of PG 58-22. In addition, the cracking resistant asphalt binder may have a higher temperature compliance than the base asphalt binder. In some embodiments (such as when the hard asphalt includes PDA pitch), the ΔT_{c} after 40-hour PAV aging of the cracking resistant asphalt binder may be higher than the ΔT_{c} after 40-hour PAV aging of the base asphalt material.

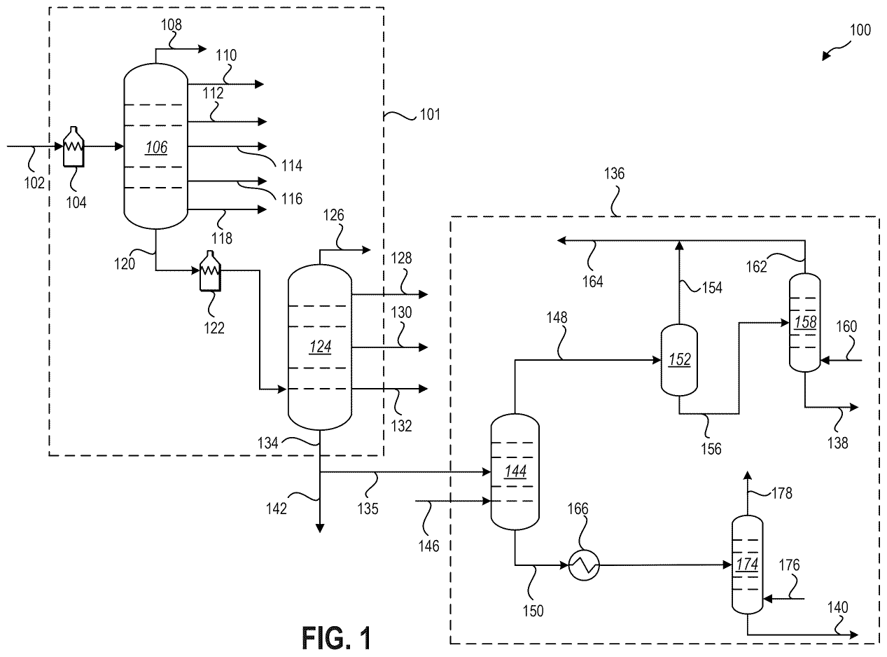

FIG. 1 is a simplified schematic of a system 100 for forming (producing, generating) a hard asphalt 140 that may be used to blend with a base asphalt material to form a blended asphalt binder comprising a cracking resistant asphalt binder, according to at least one embodiment of the disclosure. The system 100 may be a refinery, such as a petroleum or oil refinery. The system 100 may include one or more units configured to distill (refine) one or more crude oils and form one or more products therefrom. The system 100 may be configured to refine a crude oil 102 into one or more components (e.g., fractions) based, at least in part, on the boiling point of the different components. The system 100 includes a crude distillation unit 101 configured to distill (refine) the crude oil 102 and form one or more products therefrom. The crude distillation unit 101 may include an atmospheric distillation tower 106 and a vacuum distillation tower 124.

The properties of the crude oil 102 may depend on the type of crude oil 102 and may include any mixture of hydrocarbon materials. The crude oil 102 may be a low-density crude oil having an API gravity (wherein API gravity is equal to (141.5/SG)-131.5, wherein SG is the specific gravity) greater than about 40°, a medium-density crude oil having an API gravity between about 30° and about 40°, a high-density crude oil having an API gravity less than about 30°, or combinations thereof. In addition, the crude oil 102 may have a sulfur content, such as a sulfur content less than about 0.5 weight percent (e.g., a so-called “sweet” crude oil), a crude oil having a sulfur content greater than about 0.5 weight percent (e.g., a so-called “sour” crude oil), or combinations thereof. The crude oil 102 may include a paraffinic content, a naphthenic content, an aromatic content, or combinations thereof. The various fractions of the crude oil 102 may be separated from one another based on one or more of the density (gravity), the assay, or another property of the crude oil 102. Accordingly, the assay of the crude oil 102 may affect the fractions and the volume of different fractions of hydrocarbon products formed from the distillation of the crude oil 102.

The system 100 includes a furnace 104, which may also be referred to herein as a “crude furnace.” The furnace 104 may receive the crude oil 102 and provide thermal energy to the crude oil 102 to increase a temperature thereof prior to the crude oil 102 entering an atmospheric distillation tower 106 (also referred to herein as an “atmospheric distillation column” or a “crude tower”). The furnace 104 may include a cabin-type furnace, a cylindrical furnace, an A-frame furnace, or another type of furnace.

While FIG. 1 illustrates only certain components of the system 100, it will be understood that the system 100 may include components and devices in addition to those described. For example, the system 100 may include a desalter configured to remove salts and water from the crude oil 102 prior to introducing the crude oil 102 to the furnace 104 and the atmospheric distillation tower 106. In addition, the atmospheric distillation tower 106 may include additional streams (e.g., stripping steam, reflux streams, other streams) and may be in operable communication with one or more additional components (e.g., one or more pumps, heat exchangers). The system 100 may include pumps, valves, heat exchangers, or other process equipment for facilitating the recovery of hydrocarbon materials from the crude oil 102.

A temperature of the crude oil 102 entering the atmospheric distillation tower 106 may be sufficient to facilitate separation of different components within the crude oil 102 based on a boiling point range of the different components within the crude oil 102 based on the boiling point range of the different components. The temperature of the crude oil 102 entering the atmospheric distillation tower 106 may be selected based, at least in part, on the composition of the crude oil 102 (e.g., the crude assay) and an operating pressure of the atmospheric distillation tower 106. By way of non-limiting example, the temperature of the crude oil 102 may be within a range of from about 260° C. (about 550° F.) to about to 400° C. (about 752° F.), such as from about 260° C. (about 550° F.) to 315.6° C. (about 600° F.), from about 315.6° C. (about 600° F.) to about 343.3° C. (about 650° F.), from about 343.3° C. (about 650° F.) to about 371.1° C. (about 700° F.), or from about 371.1° C. (about 700° F.) to about 400° C. (about 752° F.). However, the disclosure is not so limited, and the temperature of the crude oil 102 may be different than that described.

The atmospheric distillation tower 106 may be configured to facilitate separation of the different components of the crude oil 102 from one another to form one or more hydrocarbon fractions from the crude oil 102, each hydrocarbon fraction having a different boiling point range and/or one or more different properties than the other hydrocarbon fractions. The atmospheric distillation tower 106 may include multiple trays including, for example, one or more of bubble cap trays, sieve trays, valve trays, or any other type of tray to facilitate vapor-liquid contact and separation based on boiling point. In some embodiments, the atmospheric distillation tower 106 is configured to separate the crude oil 102 into an overhead gaseous material 108 (also referred to as a “light ends” material), a light naphtha material 110, a heavy naphtha material 112, a jet material 114 (or a kerosene material), a diesel material 116, an atmospheric gas oil 118, and an atmospheric tower bottoms material 120 (which may also be referred to as “atmospheric residue”).

The overhead gaseous material 108 may include, for example, non-condensable gases and/or liquified petroleum gas (LPG). The non-condensable gases may include one or more of hydrogen, methane ethane, propane, or butane. The liquified petroleum gas may include one or more of propane, butanes, and other hydrocarbon materials. In some embodiments, the overhead gaseous material 108 is further processed in the system 100, such as in a gas recovery system.

The light naphtha material 110 may include, for example, pentane, hexane, other C₅ hydrocarbons, other C₆ hydrocarbons, or combinations thereof. The C₅ and C₆ hydrocarbons may be paraffins (e.g., n-pentane, n-hexane), isoparaffins (e.g., isopentane, isohexane), naphthenes (cyclopentane, cyclohexane), aromatics (e.g., benzene), or combinations thereof. The light naphtha material 110 may have a boiling point range from about 35° C. (about 95° F.) to about 90° C. (about 194° F.); a molecular weight range within a range of from about 70 g/mol to about 85 g/mol; a density at about 15° C. within a range of from about 0.65 g/cm³ to about 0.70 g/cm³; a Reid vapor pressure from about 6 psi to about 12 psi; a flash point less than about 0° C.; and a viscosity within a range of from about 0.4 cSt to about 0.5 cSt. The light naphtha material 110 may be further processed in the system 100, such as in a reformer and/or may be used as a blending component of gasoline. In some embodiments, the light naphtha material 110 is used as a feedstock to an isomerization unit. As used herein, a “boiling point range” refers to the temperature interval over which a material (a mixture of different materials) transitions from liquid to vapor and may be measured using a distillation test, such as ASTM D86 or ASTM D160.

The heavy naphtha material 112 may include, for example, C₇ to C₁₀ hydrocarbon materials and may include naphthenes, paraffins, higher aromatics (benzene, toluene, xylenes), or combinations thereof. The heavy naphtha material 112 may have a higher flash point, a higher boiling point range, a higher molecular weight, a higher density, and a higher viscosity than the light naphtha material 110. By way of non-limiting example, the heavy naphtha material 112 may have a boiling point range from about 90° C. (about 194° F.) to about 200° C. (about 392° F.); a molecular weight within a range of from about 85 g/mol to about 120 g/mol; a density at about 15° C. within a range of from about 0.70 g/cm³ to about 0.78 g/cm³; a Reid vapor pressure from about 3 psi to about 6 psi; a flash point within a range of from about 26.7° C. (about 80° F.) to about 37.8° C. (about 100° F.); and a viscosity within a range of from about 0.6 cSt to about 1.0 cSt. The heavy naphtha material 112 may be further processed in the system 100, such as in a catalytic reformer and/or may be used as a blending component of gasoline.

The jet material 114 may include, for example, a mixture of paraffins (e.g., from about 50 volume percent to about 70 volume percent), naphthenes (e.g., from about 20 volume percent to about 30 volume percent), and aromatics (e.g., from about 10 volume percent to about 20 volume percent). The jet material 114 may include, for example, C₉ to C₁₇ hydrocarbons. A boiling point range of the jet material 114 may be from about 175° C. to about 300° C., with a 10 percent recovery (recovered, boiled, evaporated) temperature within a range of from about 180° C. to about 211° C.; a 20 percent recovery temperature within a range of from about 199° C. to about 213° C.; a 50 percent recovery temperature within a range of from about 212° C. to about 229° C.; a 90 percent recovery temperature within a range of from about 236° C. to about 275° C.; and an endpoint temperature of about 300° C., and a minimum flash point of about 38° C. The jet material 114 may have a density within a range of from about 0.775 g/cm³ to about 0.840 g/cm³; a freezing point of about −40° C. or about −47° C.; and a viscosity less than about 8.0 cSt at about −20° C. The jet material 114 may be further processed in the system 100 to remove contaminants (e.g., mercaptans) therefrom. The jet material 114 may be blended to form a jet fuel (e.g., a jet A jet fuel, a jet A-1 jet fuel, a jet B jet fuel, or another jet fuel).

The diesel material 116 may include, for example, a mixture of paraffins (e.g., from about 30 volume percent to about 50 volume percent), naphthenes (e.g., from about 20 volume percent to about 40 volume percent), aromatics (e.g., from about 10 volume percent to about 30 volume percent), and olefins (e.g., less than about 5 volume percent). The diesel material 116 may include, for example, C₉ to C₂₀ hydrocarbon materials. A boiling point range of the diesel material 116 may be from about 220° C. to about 380° C., with an initial boiling point within a range of from about 160° C. to about 180° C.; a 10 percent recovery temperature within a range of from about 175° C. to about 210° C.; a 50 percent recovery temperature within a range of from about 210° C. to about 270° C.; a 90 percent recovery temperature within a range of from about 250° C. to about 325° C.; and an endpoint within a range of from about 275° C. to about 380° C. The diesel material 116 may exhibit a density within a range of from about 0.82 g/cm³ to about 0.85 g/cm³; a cetane number between about 40 and about 55; a minimum flash point of about 52° C.; and a viscosity between about 1.9 cSt and about 4.1 cSt at about 40° C. The diesel material 116 may be further processed in the system 100, such as in one or more hydrotreaters to remove (e.g., reduce) sulfur from the diesel material 116. The diesel material 116 may be blended to form a diesel fuel, stored in tankage, and/or provided to a terminal after removal of the sulfur therefrom.

The atmospheric gas oil (AGO) 118 may include C₁₂ to C₂₀ hydrocarbons. The atmospheric gas oil 118 may have a boiling point range from about 250° C. (e.g., about 270° C.) to about 425° C. (e.g., about 370° C.). The atmospheric gas oil 118 may include a light gas oil, a heavy gas oil, or combinations thereof. The atmospheric gas oil 118 may exhibit a viscosity within a range of from about 2 cSt to about 10 cSt at about 40° C.; a density within a range of from about 0.83 g/cm³ to about 0.88 g/cm³; and a cetane number within a range of from about 35 to about 50. The system 100 may be configured to further process the atmospheric gas oil 118, such as in a hydrotreater, a hydrocracker (e.g., a fluid catalytic cracker), or another process.

The atmospheric tower bottoms material 120 may include heavy atmospheric gas oil, asphaltenes, resins, polyaromatic hydrocarbons, and combinations thereof. The atmospheric tower bottoms material 120 may have a boiling point range from about 343° C. (about 650° F.) to about 565.6° C. (about 1,050° F.). In some embodiments, the atmospheric tower bottoms material 120 exhibits an initial boiling temperature from about 343.3° C. (about 650° F.) to about 371.1° C. (about 700° F.). A final boiling point (endpoint) of the atmospheric tower bottoms material 120 may be greater than about 565.6° C. (about 1,050° F.). The atmospheric tower bottoms material 120 may have a density within a range of from about 0.95 g/cm³ to about 1.05 g/cm³; a pour point greater than about 30° C.; a flash point greater than about 200° C.; and a viscosity greater than about 1,000 cSt at about 100° C.

With continued reference to FIG. 1, the atmospheric tower bottoms material 120 may be further processed to separate lighter fractions (e.g., fractions having a lower boiling point range than heavier fractions) from the heavier fractions (e.g., fractions having a higher boiling point range than the lighter fractions). In some embodiments, the atmospheric tower bottoms material 120 is processed in a distillation column or tower having a pressure lower than atmospheric pressure. In some embodiments, the atmospheric tower bottoms material 120 may be provided to a vacuum distillation tower 124 (also referred to as a “vacuum tower” or a “vacuum separation tower”). The vacuum distillation tower 124 may be operated at a pressure such that the vacuum distillation tower 124 is a low vacuum distillation tower and forms (among other things) a low viscosity vacuum tower bottoms material; or may be operated at a pressure such that the vacuum distillation tower 124 is a high vacuum distillation tower and forms (among other things) a high viscosity vacuum tower bottoms material.

The vacuum distillation tower 124 may be configured to receive the atmospheric tower bottoms material 120 and separate the atmospheric tower bottoms material 120 into one or more materials having different boiling point ranges, such as an overhead vapor material 126, a light vacuum gas oil (LVGO) 128 (also referred to as a “low vacuum gas oil”), a medium vacuum gas oil (MVGO) 130, a heavy vacuum gas oil (HVGO) 132 (also referred to as a “high vacuum gas oil”), and a vacuum tower bottoms material 134 (VTB or VTB material). In some embodiments, the atmospheric tower bottoms material 120 is heated in a furnace 122 prior to being provided to the vacuum distillation tower 124. The temperature of the atmospheric tower bottoms material 120 provided to the vacuum distillation tower 124 may be within a range of from about 343.4° C. (about 650° F.) to about 371.1° C. (about 700° F.). However the disclosure is not so limited and the temperature of the atmospheric tower bottoms material 120 may be different than that described.

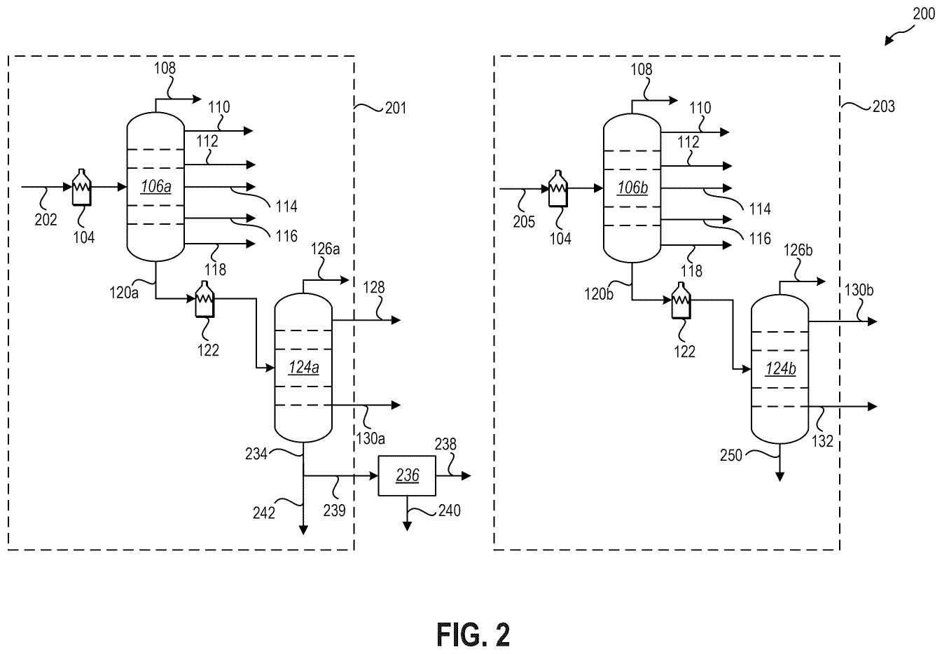

A pressure of the vacuum distillation tower 124 may be within a range of from about 5 mmHg absolute to about 100 mmHg absolute. In some embodiments, the vacuum distillation tower 124 is operated at a pressure within a range of from about 50 mmHg absolute to about 100 mmHg absolute and is a low vacuum distillation tower. In some embodiments, the vacuum distillation tower 124 is operated at a pressure within a range of from about 5 mmHg absolute to about 50 mmHg absolute, such as from about 5 mmHg to about 10 mmHg, from about 10 mmHg absolute to about 25 mmHg absolute, or from about 25 mmHg absolute to about 50 mmHg absolute and may be a high vacuum distillation tower. As described in additional detail herein with respect to FIG. 2, in some embodiments, the system 100 includes a low vacuum distillation tower (e.g., low vacuum distillation tower 124a (FIG. 2)) and a high vacuum distillation tower (e.g., high vacuum distillation tower 124b)). In some embodiments, one or more properties (e.g., a vacuum viscosity, a high temperature compliance, a low temperature compliance) of the vacuum tower bottoms material 134 depends, at least in part, on the pressure of the vacuum distillation tower 124.

The overhead vapor material 126 may include C₁ to C₄ hydrocarbon materials and may be further processed in the system 100 by, for example, the gas recovery system. The light vacuum gas oil 128 may have a boiling point ranging from about 343° C. to about 455° C.; the medium vacuum gas oil 130 may have a boiling point ranging from about 455° C. to about 510° C.; the heavy vacuum gas oil 132 may have a boiling point ranging from about 510° C. to about 566° C.; and the vacuum tower bottoms material 134 may have a boiling point range greater than about 566° C. In some embodiments, the boiling point range of the heavy vacuum gas oil 132 may be different than that described above and may be, for example, from about 455° C. to about 566° C.

While the vacuum distillation tower 124 has been described as including the medium vacuum gas oil 130, the disclosure is not so limited. In some embodiments, the vacuum distillation tower 124 does not include the medium vacuum gas oil 130 and includes the overhead vapor material 126, the light vacuum gas oil 128, the heavy vacuum gas oil 132, and the vacuum tower bottoms material 134. In some embodiments, the boiling point range of the heavy vacuum gas oil 132 may be different than that described above and may be, for example, from about 455° C. to about 566° C.

The light vacuum gas oil 128 may exhibit a density within a range of from about 0.85 g/cm³ to about 0.88 g/cm³; a viscosity within a range of from about 2 cSt to about 5 cSt at about 100° C., a pour point within a range of from about −23° C. to about −1° C.; an aromatic content within a range of from about 20 weight percent to about 40 weight percent; and a flash point greater than about 93° C. The light vacuum gas oil 128 may be further processed in the system 100, such as in a hydrocracker, may be used as a blending component, or combinations thereof.

The medium vacuum gas oil 130 may exhibit a density within a range of from about 0.88 g/cm³ to about 0.91 g/cm³; a viscosity within a range of from about 5 cSt to about 10 cSt at about 100° C., a pour point within a range of from about −6° C. to about 10° C.; an aromatic content within a range of from about 30 weight percent to about 50 weight percent; and a flash point greater than about 121° C. The medium vacuum gas oil 130 may be further processed in the system 100, such as in a hydrocracker or a catalytic cracker, may be used as a blending component, or combinations thereof.

The heavy vacuum gas oil 132 may exhibit a density within a range of from about 0.91 g/cm³ to about 0.95 g/cm³; a viscosity within a range of from about 10 cSt to about 20 cSt at about 100° C., a pour point within a range of from about 10° C. to about 27° C.; an aromatic content within a range of from about 40 weight percent to about 60 weight percent; and a flash point greater than about 149° C. The heavy vacuum gas oil 132 may be further processed in the system 100, such as in a hydrocracker or a catalytic cracker, may be used as a blending component, or combinations thereof.

A composition of the heavy vacuum gas oil 132 may be measured according to the IP 469 standard for determining the composition of saturates, aromatic, and polar compounds (including resins and asphaltenes). In some embodiments, the composition of the heavy vacuum gas oil 132 is measured using a SARA analysis. In some embodiments, the heavy vacuum gas oil 132 includes from about 46.0 weight percent to about 55.0 weight percent saturates, from about 34.0 weight percent to about 46.0 weight percent aromatics, from about 7.0 weight percent to about 15.0 weight percent resins, and from about 0.0 weight percent to about 1.0 weight percent asphaltenes.

Saturates may constitute at least about 40.0 weight percent of the heavy vacuum gas oil 132. Saturates may constitute from about 40.0 weight percent to about 60.0 weight percent of the heavy vacuum gas oil 132, such as from about 40.0 weight percent to about 45.0 weight percent, from about 45.0 weight percent to about 50.0 weight percent, from about 50.0 weight percent to about 55.0 weight percent, or from about 55.0 weight percent to about 60.0 weight percent of the heavy vacuum gas oil 132. In some embodiments, saturates constitute from about 46.0 weight percent to about 55.0 weight percent of the heavy vacuum gas oil 132. In some embodiments, saturates constitute from about 46.0 weight percent to about 55.0 weight percent of the heavy vacuum gas oil 132, such as from about 46.0 weight percent to about 50.0 weight percent, or from about 50.0 weight percent to about 55.0 weight percent of the heavy vacuum gas oil 132.

Aromatics may constitute at least about 30.0 weight percent of the heavy vacuum gas oil 132. Aromatics may constitute from about 30.0 weight percent to about 50.0 weight percent of the heavy vacuum gas oil 132, such as from about 30.0 weight percent to about 35.0 weight percent, from about 35.0 weight percent to about 40.0 weight percent, from about 40.0 weight percent to about 45.0 weight percent, or from about 45.0 weight percent to about 50.0 weight percent of the heavy vacuum gas oil 132. In some embodiments, aromatics constitute from about 34.0 weight percent to about 46.0 weight percent of the heavy vacuum gas oil 132. In some embodiments aromatics constitute from about 34.0 weight percent to about 46.0 weight percent of the heavy vacuum gas oil 132, such as from about 34.0 weight percent to about 38.0 weight percent, from about 38.0 weight percent to about 42.0 weight percent, or from about 42.0 weight percent to about 46.0 weight percent of the heavy vacuum gas oil 132.

Resins may constitute at least about 5.0 weight percent of the heavy vacuum gas oil 132. Resins may constitute from about 5.0 weight percent to about 20.0 weight percent of the heavy vacuum gas oil 132, such as from about 5.0 weight percent to about 10.0 weight percent, from about 10.0 weight percent to about 15.0 weight percent, or from about 15.0 weight percent to about 20.0 weight percent of the heavy vacuum gas oil 132. In some embodiments, resins constitute from about 7.0 weight percent to about 15.0 weight percent of the heavy vacuum gas oil 132. In some embodiments, resins constitute from about 7.0 weight percent to about 15.0 weight percent of the heavy vacuum gas oil 132, such as from about 7.0 weight percent to about 9.0 weight percent, from about 9.0 weight percent to about 12.0 weight percent, or from about 12.0 weight percent to about 15.0 weight percent of the heavy vacuum gas oil 132.

Asphaltenes may constitute less than about 2.0 weight percent, such as less than about 1.0 weight percent, less than about 0.50 weight percent, or less than about 0.10 weight percent of the heavy vacuum gas oil 132. Asphaltenes may constitute from about 0.0 weight percent to about 2.0 weight percent of the heavy vacuum gas oil 132, such as from about 0.10 weight percent to about 0.50 weight percent, from about 0.50 weight percent to about 1.0 weight percent, or from about 1.0 weight percent to about 2.0 weight percent of the heavy vacuum gas oil 132. In some embodiments, the heavy vacuum gas oil 132 is free of (e.g., substantially free of) asphaltenes. In some embodiments, asphaltenes constitute from about 0.0 weight percent to about 1.0 weight percent of the heavy vacuum gas oil 132.

A colloidal index (CI) of the heavy vacuum gas oil 132 may be within a range of from about 0.8 to about 1.2, such as from about 0.8 to about 1.0, or from about 1.0 to about 1.2. The colloidal index may be a representation of a likelihood of the heavy vacuum gas oil 132 to form sediments due to instability of the asphaltene particles therein. The colloidal index is calculated as the ratio between the aromatics and the resins to the asphaltenes and the saturates (i.e., colloidal index=(weight percent aromatics+weight percent resins)/(weight percent asphaltenes+weight percent saturates)). The colloidal instability index (CII) is the reciprocal of the colloidal index (i.e., colloidal instability index=(weight percent saturates+weight percent asphaltenes)/(weight percent resins+weight percent aromatics)).

The composition of the heavy vacuum gas oil 132 may be measured using staged thermal extraction gas chromatography-mass spectrometry (TE GC-MS) and/or using pyrolysis gas chromatography-mass spectrometry (PY GC-MS). As measured by staged thermal extraction gas chromatography-mass spectrometry, the heavy vacuum gas oil 132 may include C₁₁ to C₃₃ hydrocarbons (e.g., C₁₁ to C₃₃ vacuum gas oil-range aliphatic materials). The heavy vacuum gas oil 132 may further include a range of aliphatic materials including C₁₈ materials, trace 3 or 4 ring aromatics and thiophenes, as determined by TE GC-MS. In some embodiments, the heavy vacuum gas oil 132 includes a greater weight percent of C₁₈ hydrocarbons than other hydrocarbons, such as hydrocarbons in the C₁₁ to C₃₃ range. As measured by pyrolysis gas chromatography-mass spectrometry, the heavy vacuum gas oil 132 may not include appreciable organic materials.

The vacuum tower bottoms material 134 may exhibit an initial boiling point greater than about 566° C.; a density within a range of from about 0.98 g/cm³ to about 1.10 g/cm³; a viscosity within a range of from about 50 cSt to about 500 cSt at about 100° C.; a pour point within a range of from about 27° C. to about 65° C.; an aromatic content within a range of from about 50 weight percent to about 70 weight percent; an asphaltene content within a range of from about 5 weight percent to about 20 weight percent; and a flash point greater than about 149° C. However, the composition and properties of the vacuum tower bottoms material 134 are not so limited, and may be different than those described. The composition and properties of the vacuum tower bottoms material 134 may depend, at least in part, on the operating pressure of the vacuum distillation tower 124.

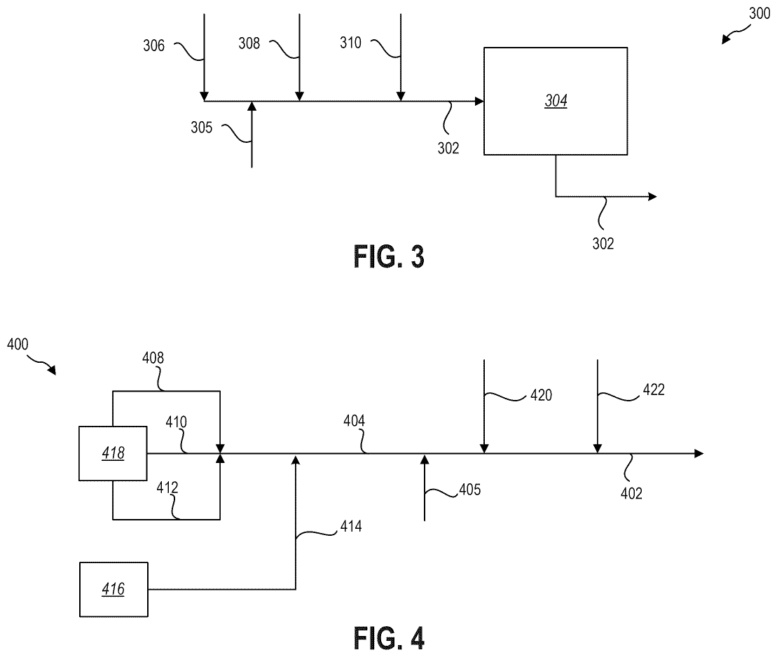

The vacuum tower bottoms material 134 may be a high viscosity vacuum tower bottoms (HVTB) material (also referred to as a “heavy vacuum tower bottoms material”) or a low viscosity vacuum tower bottoms (LVTB) material (also referred to as a “light vacuum tower bottoms material”), depending on, for example, the temperature and pressure of the vacuum distillation tower 124. As described herein, the vacuum tower bottoms material 134 may be processed in the system 100, such as in one or more of a hydrocracker, a coker, may be used in asphalt production in the formation of an asphalt binder (e.g., cracking resistant asphalt binder 302 (FIG. 3), cracking resistant asphalt binder 402 (FIG. 4)), or combinations thereof. As described herein, in some embodiments, a base asphalt binder includes the vacuum tower bottoms material 134; and a hard asphalt is blended with the vacuum tower bottoms material 134 to form a cracking resistant asphalt binder.

The vacuum tower bottoms material 134 may include a low viscosity vacuum tower bottoms material. The low viscosity vacuum tower bottoms may have a vacuum viscosity within a range of 10 P to 300 P, such as from about 1 Poise (P) to about 200 P at about 60° C. In some embodiments, the low viscosity vacuum tower bottoms material 134 has a vacuum viscosity less than about 300 P at about 60° C. In some embodiments, the low viscosity vacuum tower bottoms material 134 has a vacuum viscosity within a range of from about 10 P to about 200 P at about 60° C. In some embodiments, the vacuum viscosity of the low viscosity vacuum tower bottoms material 134 is less than about 200 P at about 60° C. As used herein, a vacuum viscosity refers to a viscosity measured according to ASTM D2171 (such as ASTM D2171/D2171M-22) measured at 60° C., which method is used to determine viscosity of asphalt index by vacuum capillary viscometers.

The low viscosity vacuum tower bottoms material may include a bimodal distribution of C₆ to C₂₅ hydrocarbons and C₂₅ to C₃₅ hydrocarbons, as measured by using staged thermal extraction gas chromatography-mass spectrometry (TE GC-MS). The C₆ to C₂₅ hydrocarbons may be aliphatic and may be in the diesel range, and the C₂₅ to C₃₅ hydrocarbons may be aliphatic and may be in the vacuum gas oil range. As measured by pyrolysis gas chromatography-mass spectrometry (PY GC-MS), the low viscosity vacuum tower bottoms material may include C₄ to C₂₃ hydrocarbons, such as a mixture of C₄ to C₂₃ olefinic and paraffinic hydrocarbons. In some embodiments, the low viscosity vacuum tower bottoms material further includes up to C₂₉ paraffins. The mixture of C₄ to C₂₃ olefinic and paraffinic hydrocarbons may include pairs of olefinic and paraffinic C₄ to C₂₃ hydrocarbons.

A distillation curve of the low viscosity vacuum tower bottoms material 134 may be determined according to, for example, ASTM D7169M. The low viscosity vacuum tower bottoms material 134 may have an initial boiling point within a range of from about 404° C. (about 760° F.) to about 426.7° C. (about 800° F.), such as from about 410° C. (about 770° F.) to about 423° C. (about 794° F.), or from about 413° C. (about 775° F.) to about 423° C. (about 794° F.). In some embodiments, the initial boiling point of the low viscosity vacuum tower bottoms material 134 is about 413° C. (about 775° F.).

A temperature at which about 10.0 weight percent of the low viscosity vacuum tower bottoms material 134 boils off (is evaporated) (a T10 temperature) may be within a range of from about 510° C. (about 950° F.) to about 565.6° C. (about 1,050° F.), such as from about 521° C. (about 970° F.) to about 554.4° C. (about 1,030° F.), from about 526.7° C. (about 980° F.) to about 548.9° C. (about 1,020° F.), or from about 532.2° C. (about 990° F.) to about 543.3° C. (about 1,010° F.). In some embodiments, the T10 temperature of the low viscosity vacuum tower bottoms material 134 is less than about 554.4° C. (about 1,030° F.), such as less than about 548.9° C. (about 1,020° F.), or less than about 543.3° C. (about 1,010° F.). In some embodiments, the T10 temperature of the low viscosity vacuum tower bottoms material 134 is about 535° C. (about 995° F.).

A temperature at which about 30.0 weight percent of the low viscosity vacuum tower bottoms material 134 boils off (is evaporated) (a T30 temperature) may be within a range of from about 565.6° C. (about 1,050° F.) to about 615.6° C. (about 1,140° F.), such as from about 576.7° C. (about 1,070° F.) to about 604.4° C. (about 1,120° F.), or from about 582.2° C. (about 1,080° F.) to about 598.9° C. (about 1,110° F.). In some embodiments, the T30 temperature of the low viscosity vacuum tower bottoms material 134 is higher than about 565.6° C. (about 1,050° F.), such as higher than about 576.7° C. (about 1,070° F.). In some embodiments, the T30 temperature of the low viscosity vacuum tower bottoms material 134 is lower than about 615.6° C. (about 1,140° F.), such as lower than about 604.4° C. (about 1,120° F.), or lower than about 593.3° C. (about 1,100° F.). In some embodiments, the T30 temperature of the low viscosity vacuum tower bottoms material 134 is about 587.8° C. (about 1,090° F.).

A temperature at which about 50.0 weight percent of the low viscosity vacuum tower bottoms material 134 boils off (is evaporated) (a T50 temperature) may be within a range of from about 621.1° C. (about 1,150° F.) to about 676.7° C. (about 1,250° F.), or from about 598.9° C. (about 1,110° F.) to about 654.4° C. (about 1,210° F.), such as from about 610° C. (about 1,130° F.) to about 643.3° C. (about 1,190° F.), or from about 621° C. (about 1,150° F.) to about 632.2° C. (about 1,170° F.). In some embodiments, the T50 temperature of the low viscosity vacuum tower bottoms material 134 is less than about 648.9° C. (about 1,200° F.), such as less than about 637.8° C. (about 1,180° F.), or less than about 632.2° C. (about 1,170° F.).

A temperature at which about 70.0 weight percent of the low viscosity vacuum tower bottoms material 134 boils off (is evaporated) (a T70 temperature) may be within a range of from about 643.3° C. (about 1,190° F.) to about 698.9° C. (about 1,290° F.), such as from about 654.4° C. (about 1,210° F.) to about 687.8° C. (about 1,270° F.), or from about 665.6° C. (about 1,230° F.) to about 676.7° C. (about 1,250° F.). In some embodiments, the T70 temperature of the low viscosity vacuum tower bottoms material 134 is less than about 682.2° C. (about 1,260° F.), such as less than about 676.7° C. (about 1,250° F.).

A temperature at which about 90.0 weight percent of the low viscosity vacuum tower bottoms material 134 boils off (is evaporated) (a T90 temperature) may be within a range of from about 676.7° C. (about 1,250° F.) to about 726.7° C. (about 1,340° F.), or from about 690.6° C. (about 1,275° F.) to about 735° C. (about 1,355° F.), such as from about 698.9° C. (about 1,290° F.) to about 726.7° C. (about 1,340° F.), or from about 707.2° C. (about 1,305° F.) to about 718.3° C. (about 1,325° F.). In some embodiments, the T90 temperature of the low viscosity vacuum tower bottoms material 134 is less than about 732.2° C. (about 1,350° F.), such as less than about 726.7° C. (about 1,340° F.), less than about 721.1° C. (about 1,330° F.), or less than about 715.6° C. (about 1,320° F.).

An endpoint temperature of the low viscosity vacuum tower bottoms material 134 (a temperature at which substantially all of the low viscosity vacuum tower bottoms material 134 evaporates) may be within a range of from about 704.4° C. (about 1,300° F.) to about 748.9° C. (about 1,380° F.), such as from about 732.2° C. (about 1,350° F.) to about 743.3° C. (about 1,370° F.). In some embodiments, the endpoint temperature of the low viscosity vacuum tower bottoms material 134 is within a range of from about 715.6° C. (about 1,320° F.) to about 771.1° C. (about 1,420° F.), such as from about 726.7° C. (about 1,340° F.) to about 760° C. (about 1,400° F.), or from about 737.8° C. (about 1,360° F.) to about 748.9° C. (about 1,380° F.). In some embodiments, the endpoint temperature of the low viscosity vacuum tower bottoms material 134 is less than about 760° C. (about 1,400° F.), such as less than about 754.4° C. (about 1,390° F.), or less than about 748.9° C. (about 1,380° F.).

A composition of the low viscosity vacuum tower bottoms material may be measured according to the IP 469 standard for determining the composition of saturates, aromatic, and polar compounds (including resins and asphaltenes) (a SARA analysis). As measured by the IP 469 standard, in some embodiments, the low viscosity vacuum tower bottoms material includes from about 22.0 weight percent to about 35.0 weight percent saturates (such as from about 24.0 weight percent to about 33.0 weight percent saturates, from about 25.0 weight percent to about 32.0 weight percent saturates, or from about 26.1 weight percent to about 31.0 weight percent saturates), from about 30.0 weight percent to about 45.0 weight percent aromatics (such as from about 38.0 weight percent to about 42.0 weight percent resins or from about 38.9 weight percent to about 43.7 weight percent aromatics), from about 15.0 weight percent to about 25.0 weight percent resins (such as from about 18.0 weight percent to about 22.0 weight percent resins, or from about 15.5 weight percent to about 16.5 weight percent resins), and from about 10.0 weight percent to about 15.0 weight percent asphaltenes (such as from about 11.0 weight percent to about 14.0 weight percent asphaltenes, or from about 13.0 weight percent to about 14.5 weight percent asphaltenes). However, the disclosure is not so limited, and the composition of the low viscosity vacuum tower bottoms material may be different than that described. In some embodiments, the low viscosity vacuum tower bottoms material includes from about 26.1 weight percent to about 31.0 weight percent saturates; from about 38.9 weight percent to about 43.7 weight percent aromatics; from about 15.5 weight percent to about 16.5 weight percent resins; and from about 13.0 weight percent to about 14.5 weight percent asphaltenes.

In some embodiments, the vacuum tower bottoms material 134 includes a high viscosity vacuum tower bottoms material, such as when the vacuum tower bottoms material 134 is operated at a pressure within a range of from about 5.0 mmHg absolute to about 50 mmHg absolute. The high viscosity vacuum tower bottoms material may have a vacuum viscosity within a range of from about 60,000 P to about 200,000 P, such as from about 60,000 P to about 100,000 P, from about 100,000 P to about 150,000 P, or from about 150,000 P to about 200,000 P. The vacuum viscosity is measured at a temperature of 60° C. In some embodiments, the high viscosity vacuum tower bottoms material has a viscosity greater than about 60,000 P, such as greater than about 100,000 P, or greater than about 150,000 P at 60° C. In some embodiments, the high viscosity vacuum tower bottoms material does not substantially flow at room temperature (e.g., at a temperature within a range of from about 20° C. to about 25° C.).

The high viscosity vacuum tower bottoms material may exhibit a high temperature compliance (as measured by DSR) greater than 85° C. For example, the high temperature compliance of the high viscosity vacuum tower bottoms material may be within a range of from about 85° C. to about 95° C., such as from about 85° C. to about 87° C., from about 87° C. to about 90° C., from about 90° C. to about 92° C., or from about 92° C. to about 95° C. In some embodiments, the high temperature compliance of the high viscosity vacuum tower bottoms material is within a range of from about 87° C. to about 95° C. The high temperature compliance of the high viscosity vacuum tower bottoms material may be greater than about 87° C., such as greater than about 90° C., or greater than about 92° C.

A low temperature compliance of an unaged and/or a 20-hour PAV aged high viscosity vacuum tower bottoms material may be within a range of from about −9° C. to about 0° C., such as from about −9° C. to about −6° C., from about −6° C. to about −3° C., or from about −3° C. to about 0° C. The low temperature compliance of a 20-hour PAV aged high viscosity vacuum tower bottoms material may be less than about 0° C., such as less than about −3° C., or less than about −6° C. The low temperature compliance of a 20-hour PAV aged high viscosity vacuum tower bottoms material may be less than about 0° C., such as less than about −3° C., or less than about −6° C. A usable temperature range of the high viscosity vacuum tower bottoms material may be greater than about 90° C., such as greater than about 92° C., greater than about 93° C., greater than about 94° C., greater than about 95° C., or even greater than about 96° C.

A ΔT_{c} of the high viscosity vacuum tower bottoms material may be greater than about −5° C. In other words, a minimum ΔT_{c} of the high viscosity vacuum tower bottoms may be about −5° C. In some embodiments, the ΔT_{c} of a 20-hour PAV aged or a 40-hour PAV aged high viscosity vacuum tower bottoms material is greater than about −5° C., such as greater than about −4° C., −2° C., or 0° C. In other words, the ΔT_{c} of the high viscosity vacuum tower bottoms material may be greater than about −5° C. after aging for 20 hours and after aging for 40 hours in a PAV. In some embodiments, the ΔT_{c} of the high viscosity vacuum tower bottoms material after 20 hours of PAV aging is higher than about −3.0° C., or even higher than about −2.5° C. The ΔT_{c} of the high viscosity vacuum tower bottoms material after 40 hours of PAV aging is higher than about −4.5° C., such as higher than about −4.0° C., or higher than about −3.5° C.

The distillation curve of the high viscosity vacuum tower bottoms material may be determined according to, for example, ASTM D7169M. The high viscosity vacuum tower bottoms material may have an initial boiling point within a range of from about 480° C. (about 896° F.) to about 510° C. (about 950° F.). In some embodiments, the initial boiling point of the high viscosity vacuum tower bottoms material is higher than about 482.2° C. (about 900° F.). A temperature at which about 10.0 weight percent of the high viscosity vacuum tower bottoms material boils off (is evaporated) (a T10 temperature) may be within a range of from about 537.8° C. (about 1,000° F.) to about 593.3° C. (about 1,100° F.).

A temperature at which about 30.0 weight percent of the high viscosity vacuum tower bottoms material boils off (is evaporated) (a T30 temperature) may be within a range of from about 593.3° C. (about 1,100° F.) to about 648.9° C. (about 1,200° F.), such as from about 600° C. (about 1,112° F.) to about 640° C. (about 1,184° F.), or from about 610° C. (about 1,130° F.) to about 630° C. (about 1,166° F.). In some embodiments, the T30 temperature of the high viscosity vacuum tower bottoms material is higher than about 600° C. (about 1,112° F.), such as higher than about 610° C. (about 1,130° F.). In some embodiments, the T30 temperature of the high viscosity vacuum tower bottoms material is about 621° C. (about 1150° F.).

A temperature at which about 50.0 weight percent of the high viscosity vacuum tower bottoms material boils off (is evaporated) (a T50 temperature) may be within a range of from about 648.9° C. (about 1,200° F.) to about 687.8° C. (about 1,270° F.), such as from about 650° C. (about 1,202° F.) to about 685° C. (about 1,265° F.), or from about 655° C. (about 1,211° F.) to about 675° C. (about 1,247° F.). In some embodiments, the T50 temperature of the high viscosity vacuum tower bottoms material is higher than about 650° C. (about 1,202° F.), such as higher than about 655° C. (about 1,211° F.). In some embodiments, the T50 temperature of the high viscosity vacuum tower bottoms material is about 665° C. (about 1229° F.).

A temperature at which about 70.0 weight percent of the high viscosity vacuum tower bottoms material boils off (is evaporated) (a T70 temperature) may be within a range of from about 687.8° C. (about 1,270° F.) to about 721.1° C. (about 1,330° F.), such as from about 690° C. (about 1,274° F.) to about 720° C. (about 1,328° F.), or from about 695° C. (about 1,283° F.) to about 715° C. (about 1,319° F.). In some embodiments, the T70 temperature of the high viscosity vacuum tower bottoms material is higher than about 690° C. (about 1,274° F.), such as higher than about 695° C. (about 1,283° F.). In some embodiments, the T70 temperature of the high viscosity vacuum tower bottoms material is about 704° C. (about 1299° F.).

A temperature at which about 90.0 weight percent of the high viscosity vacuum tower bottoms material boils off (is evaporated) (a T90 temperature) may be within a range of from about 760.0° C. (about 1,400° F.) to about 776.7° C. (about 1,430° F.), such as from about 765.6° C. (about 1,410° F.) to about 782.2° C. (about 1,440° F.). In some embodiments, the T90 temperature is within a range of from about 760.0° C. (about 1,400° F.) to about 776.7° C. (about 1,430° F.). In some embodiments, the T90 temperature of the high viscosity vacuum tower bottoms material is higher than about 760.0° C. (about 1,400° F.), such as higher than about 771.1° C. (about 1,420° F.).

An endpoint temperature of the high viscosity vacuum tower bottoms material (a temperature at which substantially all of the high viscosity vacuum tower bottoms material evaporates) may be within a range of from about 787.8° C. (about 1,450° F.) to about 843.3° C. (about 1,550° F.), such as from about 804.4° C. (about 1,480° F.) to about 826.7° C. (about 1,520° F.). In some embodiments, the endpoint temperature of the high viscosity vacuum tower bottoms material is than about 810° C. (about 1,490° F.), such as higher than about 815.6° C. (about 1,500° F.). In some embodiments, the endpoint temperature of the high viscosity vacuum tower bottoms material is about 820° C. (about 1,508° F.).

A composition of the high viscosity vacuum tower bottoms material may be measured according to the IP 469 standard for determining the composition of saturates, aromatic, and polar compounds (including resins and asphaltenes) (a SARA analysis). As measured by the IP 469 standard, the high viscosity vacuum tower bottoms material may include from about 3.0 weight percent to about 5.0 weight percent saturates, from about 30.0 weight percent to about 45.0 weight percent aromatics, from about 29.0 weight percent to about 45.0 weight percent resins, and from about 21.0 weight percent to about 25.0 weight percent asphaltenes. However, the disclosure is not so limited, and the composition of the high viscosity vacuum tower bottoms material may be different than that described.

Saturates may constitute at least about 2.0 weight percent of the high viscosity vacuum tower bottoms material, such as at least about 3.0 weight percent of the high viscosity vacuum tower bottoms material. Saturates may constitute from about 2.0 weight percent to about 10.0 weight percent of the high viscosity vacuum tower bottoms material, such as from about 2.0 weight percent to about 3.0 weight percent, from about 3.0 weight percent to about 4.0 weight percent, from about 4.0 weight percent to about 5.0 weight percent, from about 5.0 weight percent to about 7.0 weight percent, or from about 7.0 weight percent to about 10.0 weight percent of the high viscosity vacuum tower bottoms material. In some embodiments, saturates constitute from about 3.0 weight percent to about 5.0 weight percent of the high viscosity vacuum tower bottoms material, such as from about 3.0 weight percent to about 4.0 weight percent, or from about 4.0 weight percent to about 5.0 weight percent of the high viscosity vacuum tower bottoms material.

Aromatics may constitute at least about 20.0 weight percent of the high viscosity vacuum tower bottoms material, such as at least about 25.0 weight percent, or at least about 30.0 weight percent of the high viscosity vacuum tower bottoms material. Aromatics may constitute from about 20.0 weight percent to about 50.0 weight percent (e.g., from about 30.0 weight percent to about 50.0 weight percent) of the high viscosity vacuum tower bottoms material, such as from about 20.0 weight percent to about 30.0 weight percent, from about 30.0 weight percent to about 35.0 weight percent, from about 35.0 weight percent to about 40.0 weight percent, from about 40.0 weight percent to about 45.0 weight percent, or from about 45.0 weight percent to about 50.0 weight percent of the high viscosity vacuum tower bottoms material.

Resins may constitute at least about 20.0 weight percent of the high viscosity vacuum tower bottoms material, such as at least about 25.0 weight percent of the high viscosity vacuum tower bottoms material. Resins may constitute from about 20.0 weight percent to about 50.0 weight percent (e.g., from about 29.0 weight percent to about 45.0 weight percent) of the high viscosity vacuum tower bottoms material, such as from about 20.0 weight percent to about 29.0 weight percent, from about 29.0 weight percent to about 35.0 weight percent, from about 35.0 weight percent to about 40.0 weight percent, from about 40.0 weight percent to about 45.0, or from about 45.0 weight percent to about 50.0 weight percent of the high viscosity vacuum tower bottoms material.

Asphaltenes may constitute at least about 15.0 weight percent of the high viscosity vacuum tower bottoms material, such as at least about 20.0 weight percent of the high viscosity vacuum tower bottoms material. Asphaltenes may constitute from about 15.0 weight percent to about 35.0 weight percent (e.g., from about 21.0 weight percent to about 25.0 weight percent) of the high viscosity vacuum tower bottoms material, such as from about 15.0 weight percent to about 18.0 weight percent, from about 18.0 weight percent to about 21.0 weight percent, from about 21.0 weight percent to about 23.0 weight percent, from about 23.0 weight percent to about 25.0 weight percent, from about 27.0 weight percent to about 30.0 weight percent, or from about 30.0 weight percent to about 35.0 weight percent of the high viscosity vacuum tower bottoms material. The high viscosity vacuum tower bottoms material may exhibit a colloidal index within a range of from about 0.30 to about 0.40, such as from about 0.30 to about 0.35, or from about 0.35 to about 0.40.

The high viscosity vacuum tower bottoms material may exhibit a colloidal instability index within a range of from about 0.30 to about 0.40, such as from about 0.30 to about 0.35, or from about 0.35 to about 0.40.

With continued reference to FIG. 1, the vacuum tower bottoms material 134 may be further processed and/or provided as a blend component, such as a component of an asphalt binder. The vacuum tower bottoms material 134 can be further processed in the system 100 to form lighter and more valuable products. In some embodiments, the system 100 further includes an asphalt processing system 136 configured to remove (e.g., strip, extract) asphaltenes and heavier residual components from at least a first portion 135 of the vacuum tower bottoms material 134 or other heavy oil streams to produce a deasphalted oil (DAO)) 138 and a hard asphalt 140 (also referred to as “solvent deasphalted oil (SDO),” “pitch,” “SDA pitch,” or “0-10 pen” (short for 0-10 dmm penetration)). In embodiments where the vacuum tower bottoms material 134 is a low viscosity vacuum tower bottoms material, the first portion 135 of the vacuum tower bottoms material 134 is processed in the asphalt processing system 136 and a second portion 142 of the vacuum tower bottoms material 134 may be further processed elsewhere in the system 100, provided to tankage (e.g., a heated tank), and/or provided to a mixing terminal to blend into an asphalt binder. In some embodiments, at least a portion (e.g., the second portion 142) of the vacuum tower bottoms material 134 is provided as a component of an asphalt binder, as described in additional detail herein. In some such embodiments, the second portion 142 may be blended with one or more additional components of an asphalt binder (e.g., with a portion of the heavy vacuum gas oil 132 and/or with at least one biomaterial), as described in additional detail herein.

While FIG. 1 illustrates the asphalt processing system 136 including a particular configuration, the disclosure is not so limited, and the asphalt processing system 136 may include a different configuration and different components and structures than those described and illustrated. In some embodiments, the asphalt processing system 136 includes an asphaltene separator 144, also referred to as a “deasphalting column,” a “deasphalting tower,” an “asphaltene extractor,” or an “extractor” configured to receive the first portion 135 of the vacuum tower bottoms material 134 and a solvent 146. The asphaltene separator 144 may be configured to facilitate contact between the first portion 135 of the vacuum tower bottoms material 134 and the solvent 146.

In some embodiments, the solvent 146 is provided to a lower portion of the asphaltene separator 144 than the first portion 135 of the vacuum tower bottoms material 134 and the solvent 146. The solvent 146 may flow countercurrent to the vacuum tower bottoms material 134 in the asphaltene separator 144. In other embodiments, the asphaltene separator 144 is designed such that the solvent 146 and the first portion 135 of the vacuum tower bottoms material 134 flow co-currently and/or are introduced into the asphaltene separator 144 at the same location.

The solvent 146 may be formulated and configured to dissolve lighter components (e.g., lighter oil fractions) of the first portion 135 of the vacuum tower bottoms material 134 to form an asphaltene separator overhead 148 (also referred to as a solvent-rich deasphalted oil) including the lighter components, and a precipitate including a asphaltene separator bottoms material 150. In some embodiments, the solvent 146 is configured to extract the lighter components from the vacuum tower bottoms material 134 to form the asphaltene separator bottoms material 150 including a lower amount of the lighter components than the vacuum tower bottoms material 134. The composition of the solvent 146 may affect the amount of asphaltenes removed from the first portion 135 of the vacuum tower bottoms material 134 and the amount of asphaltenes remaining in the asphaltene separator bottoms material 150.

The solvent 146 may include, for example, propane, n-butane, isobutane, pentane, or a combination thereof. In some embodiments, the solvent 146 includes propane and the asphalt processing system 136 includes a propane deasphalting unit, the deasphalted oil 138 includes propane deasphalted oil, and the hard asphalt 140 includes propane deasphalting (PDA) pitch.

In some embodiments, the solvent 146 includes n-butane and isobutane and the asphalt processing system 136 includes a solvent deasphalting unit, the deasphalted oil 138 includes solvent deasphalted oil, and the hard asphalt 140 includes solvent deasphalting (SDA) pitch. The use of n-butane and/or isobutane in the solvent 146 may increase the molecular weight of the deasphalted oil 138 generated compared to the use of a solvent 146 including propane. In some embodiments, the solvent 146 includes from about 11.0 volume percent to about 99.0 volume percent n-butane, and from about 1.0 volume percent to about 82.0 volume percent isobutane. For example, the solvent 146 may include from about 11.0 volume percent to about 99.0 volume percent n-butane, such as from about 11.0 volume percent to about 30.0 volume percent, from about 30.0 volume percent to about 50.0 volume percent, from about 50.0 volume percent to about 70.0 volume percent, from about 70.0 volume percent to about 90.0 volume percent, or from about 90.0 volume percent to about 99.0 volume percent n-butane; and from about 1.0 volume percent to about 82.0 volume percent isobutane, such as from about 1.0 volume percent to about 20.0 volume percent, from about 20.0 volume percent to about 40.0 volume percent, from about 40.0 volume percent to about 60.0 volume percent, or from about 60.0 volume percent to about 82.0 volume percent isobutane. In some embodiments, the solvent 146 includes a greater volume percent of the n-butane than of the isobutane. In some embodiments, the solvent 146 includes a greater volume percent of the isobutane than of the n-butane.

In some embodiments, the pressure of the asphaltene separator 144 may be sufficient to maintain the solvent 146 in a liquid phase. For example, when the solvent 146 includes propane, the pressure of the asphaltene separator 144 may be within a range of from about 2,070 kPa (about 300 psi) to about 3,450 kPa (about 500 psi), such as from about 2,070 kPa (about 300 psi) to about 2,500 kPa (about 363 psi), from about 2,500 kPa (about 363 psi) to about 3,000 kPa (about 435 psi), or from about 3,000 kPa (about 435 psi) to about 3,450 kPa (about 500 psi). When the solvent 146 includes n-butane and/or isobutane, the pressure of the asphaltene separator 144 may be within a range of from about 689 kPa (about 100 psi) to about 5,516 kPa (about 800 psi), such as from about 689 kPa (about 100 psi) to about 1,000 kPa (about 145 psi), from about 1,000 kPa (about 145 psi) to about 1,500 kPa (about 218 psi), or from about 1,500 kPa (about 218 psi) to about 2,070 kPa (about 300 psi), from about 2,070 kPa (about 300 psi) to about 2,758 kPa (about 400 psi), from about 2,758 kPa (about 400 psi) to about 3,447 kPa (about 500 psi), from about 3,447 kPa (about 500 psi) to about 4,137 kPa (about 600 psi), from about 4,137 kPa (about 600 psi) to about 4,826 kPa (about 700 psi), or from about 4,826 kPa (about 700 psi) to about 5,516 kPa (about 800 psi). In some embodiments, relatively higher pressures of the asphaltene separator 148 may reduce the amount of the deasphalted oil 138 generated and relatively lower pressures of the asphaltene separator 148 may increase the amount of the deasphalted oil 138 generated but may extract undesired heavy fractions in the deasphalted oil 138 and result in increased DAO lift, but may also result in undesired deasphalted oil carryover.

A temperature of the asphaltene separator 144 may depend, at least in part, on the composition of the solvent 146. The temperature of the asphaltene separator 144 may be within a range of from about 48.9° C. (about 120° F.) to about 176.7° C. (about 350° F.). For example, when the solvent 146 includes propane, the temperature of the asphaltene separator 144 may be within a range of from about 48.9° C. (about 120° F.) to about 71.1° C. (about 160° F.). When the solvent 146 includes n-butane and/or isobutane, the temperature of the asphaltene separator 144 may be within a range of from about 65.6° C. (about 150° F.) to about 137.8° C. (about 280° F.), such as from about 65.6° C. (about 150° F.) to about 93.3° C. (about 200° F.), from about 93.3° C. (about 200° F.) to about 121.1° C. (about 250° F.), or from about 121.1° C. (about 250° F.) to about 137.8° C. (about 280° F.). In some embodiments, where the solvent 146 includes pentane, the temperature may be within a range of from about 93.3° C. (about 200° F.) to about 176.7° C. (about 350° F.), such as from about 93.3° C. (about 200° F.) to about 148.9° C. (about 300° F.), or from about 148.9° C. (about 300° F.) to about 176.7° C. (about 350° F.).

With continued reference to FIG. 1, the asphalt processing system 136 may include a solvent recovery system configured to recover the solvent 146 that may be present in the asphaltene separator overhead 148 and the asphaltene separator bottoms material 150. The asphalt processing system 136 may include, for example, a separator 152 (also referred to as a “deasphalted oil separator” or a “DAO separator”) configured to separate the solvent 146 from the asphaltene separator overhead 148 to form a recovered solvent 154 and a deasphalted oil material 156. In some embodiments, the separator 152 is configured to operate at supercritical conditions to separate the recovered solvent 154 from the deasphalted oil material 156. In some embodiments, the asphalt processing system 136 includes a deasphalted oil stripper 158 and the deasphalted oil material 156 is provided to a deasphalted oil stripper 158 where the deasphalted oil material 156 is contacted (e.g., stripped) with steam 160 to recover additional solvent 162 from the deasphalted oil material 156 and form the deasphalted oil 138. The deasphalted oil stripper 158 may include, for example, trays configured to facilitate contact between the steam 160 and the deasphalted oil material 156 to facilitate the separation of the additional solvent 162 from the deasphalted oil material 156 to form the deasphalted oil 138.

In some embodiments, the recovered solvent 154 and the additional solvent 162 are mixed to form a recycle solvent 164. The recycle solvent 164 may be recycled to the solvent 146 provided to the asphaltene separator 144. In some embodiments, the asphaltene separator bottoms material 150 may be further treated to remove solvent entrained therein. With reference to FIG. 1, the asphaltene separator bottoms material 150 may be provided to a heat exchanger 166 configured to increase a temperature of the asphaltene separator bottoms material 150 prior to providing the asphaltene separator bottoms material 150 to an asphalt stripper 174 where the asphaltene separator bottoms material 150 is contacted (e.g., stripped) with steam 176 to recover solvent 178 from the asphaltene separator bottoms material 150 and form the hard asphalt 140. The asphalt stripper 174 may include, for example, trays configured to facilitate contact between the steam 176 and the asphaltene separator bottoms material 150 to facilitate the separation of the solvent 178 from the asphaltene separator bottoms material 150 to form the hard asphalt 140. The asphalt stripper 174 may be substantially the same as the deasphalted oil stripper 158.

In some embodiments, the solvent 178 may be recycled to the solvent 146 provided to the asphaltene separator 144. In some embodiments, steam or condensed water may be removed from the solvent 178 to recycling to the solvent 146.

The conditions of the asphalt processing system 136, as well as the properties of the first portion 135 of the vacuum tower bottoms material 134 (and, the conditions of the vacuum distillation tower 124) may affect the properties of the hard asphalt 140. The hard asphalt 140 may exhibit a vacuum viscosity greater than about 200,000 P at about 60° C., such as greater than about 500,000 P, greater than about 750,000 P, greater than about 1,000,000 P, greater than about 1,500,000 P, greater than about 2,000,000 P, greater than about 3,000,000 P, greater than about 4,000,000 P, or even greater than about 5,000,000 P at about 60° C. The vacuum viscosity of the hard asphalt 140 at about 60° C. may be greater than the vacuum viscosity of the first portion 135 of the vacuum tower bottoms material 134 at about 60° C. In some embodiments, the vacuum viscosity of the hard asphalt 140 is greater than about 1,000,000 P at about 60° C. In some embodiments, the rotational viscosity of the hard asphalt 140 is greater than about 10,000 cP at about 135° C., such as greater than about 20,000 cP, greater than about 30,000 cP, greater than about 40,000 cP, or greater than about 50,000 cP at about 135° C.

A penetration of the hard asphalt 140 may be measured with a penetration test wherein the hard asphalt 140 is placed in a standardized container, cooled to about 25° C., and a needle is allowed to penetrate the sample under a load of about 100 grams for 5 seconds. The depth of the needle is measured and recorded in tenths of a millimeter (dmm). The hard asphalt 140 may exhibit a penetration within a range of from about 0.0 dmm to about 10 dmm at about 25° C., such as from about 0.0 dmm to about 1.0 dmm, from about 1.0 dmm to about 2.0 dmm, from about 2.0 dmm to about 4.0 dmm, from about 4.0 dmm to about 6.0 dmm, from about 6.0 dmm to about 8.0 dmm, or from about 8.0 dmm to about 10.0 dmm at about 25° C. In some embodiments, the penetration of the hard asphalt 140 is less than about 20 dmm, such as less than about 15 dmm, less than about 10 dmm, less than about 5.0 dmm, less than about 3.0 dmm, less than about 2.0 dmm, less than about 1.0 dmm, less than about 0.5 dmm, less than about 0.2 dmm, or even less than about 0.1 dmm. In some embodiments, the penetration of the hard asphalt 140 at about 25° C. is about 0 dmm (e.g., no penetration).

The hard asphalt 140 may exhibit a softening point within a range of from about 65.6° C. (about 150° F.) to about 104.4° C. (about 220° F.), such as from about 65.6° C. (about 150° F.) to about 76.7° C. (about 170° F.), from about 76.7° C. (about 170° F.) to about 87.9° C. (about 190° F.), from about 87.9° C. (about 190° F.) to about 93.3° C. (about 200° F.), from about 93.3° C. (about 200° F.) to about 98.9° C. (about 210° F.), or from about 98.9° C. (about 210° F.) to about 104.4° C. (about 220° F.). In some embodiments, the softening point of the hard asphalt 140 is greater than about 93.3° C. (about 200° F.), such as greater than about 98.9° C. (about 210° F.), or greater than about 104.4° C. (about 220° F.). In some embodiments, the softening point of the hard asphalt 140 is within a range of from about 82.2° C. (about 180° F.) to about 104.4° C. (about 220° F.). The softening point of the hard asphalt 140 may be (correspond to) the temperature at which the hard asphalt 140 transitions from a solid (or stiff and/or material that does not substantially flow) phase to a more pliable or semi-liquid phase under specific conditions. The softening point may be determined using standardized tests, such as the Ring-and-Ball test (ASTM D36 or EN 1427) wherein a steel ball is placed on a sample of the hard asphalt 140 and the temperature is increased at a controlled rate. The softening point is the temperature where the hard asphalt 140 softens to allow the ball to drop a specified distance (about 25 mm). The steel ball may have a weight of about 3.5 grams.

The hard asphalt 140 may exhibit a high temperature compliance of at least about 85° C., such as at least about 86° C., at least about 87° C., at least about 88° C., at least about 89° C., or even at least about 90° C. In some embodiments, the high temperature compliance of the hard asphalt 140 is less than the high temperature compliance of the first portion 135 of the vacuum tower bottoms material 134. The hard asphalt 140 may exhibit a low temperature compliance greater than about −12° C., such as greater than about −10° C., greater than about −8° C., greater than about-6° C., or greater than about −5° C.

In some embodiments, as measured by TE GC-MS, the hard asphalt 140 may include a bimodal distribution of C₆ to C₂₈ hydrocarbons and C₂₈ to C₃₉ gas oil. The C₆ to C₂₈ hydrocarbons may be aliphatic hydrocarbons, such as distillate range aliphatic compounds. The C₂₈ to C₃₉ hydrocarbons may be aliphatic hydrocarbons, such as gas-oil range aliphatic hydrocarbons. As measured by PY GC-MS, the hard asphalt 140 may include C₆ to C₂₅ hydrocarbons, such as a mixture of C₆ to C₂₅ olefinic and paraffinic hydrocarbons. In some embodiments, the hard asphalt 140 further includes up to C₄₀ paraffins. The mixture of C₆ to C₂₅ olefinic and paraffinic hydrocarbons may include pairs of olefinic and paraffinic C₆ to C₂₅ hydrocarbons.

As described above herein, the composition and properties of the deasphalted oil 138 and the hard asphalt 140 (e.g., PDA pitch or SDA pitch) may depend, at least in part, on the solvent 146. In some embodiments where the solvent 146 includes n-butane and/or isobutane, the hard asphalt 140 includes SDA pitch. In embodiments where the hard asphalt 140 includes SDA pitch, the SDA pitch may include from about 0.8 weight percent to about 3.8 weight percent of saturates, from about 24.0 weight percent to about 41.6 weight percent of aromatics, from about 25.6 weight percent to about 37.7 weight percent of resins, and from about 16.8 weight percent to about 25.6 weight percent of asphaltenes, as measured by the IP 469 standard, the hexane method, and/or IATROSCAN-SARA testing (which is based on thin layer chromatography with flame ionization detection (TLC-FID)). A colloidal index of the SDA pitch may be within a range of from about 0.268 to about 0.388, such as from about 0.268 to about 0.290, from about 0.290 to about 0.320, from about 0.320 to about 0.350, or from about 0.350 to about 0.388.

By way of non-limiting example, saturates may constitute from about 0.8 weight percent to about 3.8 weight percent of the SDA pitch, such as from about 0.8 weight percent to about 1.5 weight percent, from about 1.5 weight percent to about 2.0 weight percent, from about 2.0 weight percent to about 3.0 weight percent, or from about 3.0 weight percent to about 3.8 weight percent of the SDA pitch. Aromatics may constitute from about 24.0 weight percent to about 41.6 weight percent of the SDA pitch, such as from about 24.0 weight percent to about 30.0 weight percent, from about 30.0 weight percent to about 35.0 weight percent, from about 35.0 weight percent to about 40.0 weight percent, or from about 40.0 weight percent to about 41.6 weight percent of the SDA pitch. Resins may constitute from about 25.6 weight percent to about 37.7 weight percent of the SDA pitch, such as from about 25.6 weight percent to about 30.0 weight percent, from about 30.0 weight percent to about 35.0 weight percent, or from about 35.0 weight percent to about 37.7 weight percent of the SDA pitch. Asphaltenes may constitute from about 16.8 weight percent to about 25.6 weight percent of the SDA pitch, such as from about 16.8 weight percent to about 20.0 weight percent, from about 20.0 weight percent to about 23.0 weight percent, or from about 23.0 weight percent to about 25.6 weight percent of the SDA pitch. In some embodiments, the SDA pitch includes asphaltenes and resins. In some embodiments, the SDA pitch includes at least about 10.0 weight percent asphaltenes, such as at least about 15.0 weight percent, at least about 20.0 weight percent, or at least about 23.0 weight percent asphaltenes. The SDA pitch may include at least about 20.0 weight percent resins, such as at least about 25.0 weight percent, at least about 30.0 weight percent, or even at least about 35.0 weight percent resins. In some embodiments, the SDA pitch includes at least 10.0 weight percent aromatics, such as at least about 15.0 weight percent, or at least about 20.0 weight percent aromatics.

In some embodiments, a weight ratio of the resins to the aromatics in the SDA pitch is greater than about 6.0:1.0. In other words, for every about 1.0 part by weight of aromatics in the SDA pitch, the SDA pitch may include at least about 6.0 parts by weight of resin. The SDA pitch may include at least about 6.0 parts by weight of the resin for every about 1.0 part by weight of aromatics, such as at least about 10.0 parts by weight, at least about 20.0 parts by weight, at least about 30.0 parts by weight, at least about 40.0 parts by weight, or even at least about 50.0 parts by weight of resin for every about 1.0 part by weight of aromatics. In some embodiments, the relatively high ratio of the resins in the SDA pitch may increase the ductility and adhesion of the asphalt binder formed from the SDA pitch. In some embodiments, the SDA includes at least about 0.5 part by weight of the aromatics for every about 1.0 part by weight of asphaltenes.

In some embodiments, the hard asphalt 140 includes PDA pitch. The PDA pitch may include from about 0.0 weight percent to about 1.0 weight percent saturates, from about 60.0 weight percent to about 70.0 weight percent aromatics, from about 20.0 weight percent to about 30.0 weight percent resins, and from about 10.0 weight percent to about 20.0 weight percent asphaltenes, as measured by IP 469 standard. As measured by the hexane method, the PDA pitch may include from about 0.0 weight percent to about 1.0 weight percent saturates, from about 50.0 weight percent to about 60.0 weight percent aromatics, from about 30.0 weight percent to about 35.0 weight percent resins, and from about 10.0 weight percent to about 15.0 weight percent asphaltenes. In some embodiments, the PDA pitch includes at least some resins and at least some asphaltenes. For example, the PDA pitch may include at least about 20.0 weight percent resins, such as at least about 25.0 weight percent, at least about 30.0 weight percent, or even at least about 35.0 weight percent resins. The PDA pitch may include at least about 5.0 weight percent asphaltenes, such as at least about 10.0 weight percent, or at least about 15.0 weight percent asphaltenes. The PDA pitch may include at least about 40.0 weight percent aromatics, such as at least about 45.0 weight percent, or at least about 50.0 weight percent aromatics. A colloidal index of the PDA pitch may be within a range of from about 0.09 to about 0.20, such as from about 0.09 to about 0.12, from about 0.12 to about 0.15, from about 0.15 to about 0.18, or from about 0.18 to about 0.20.

A saturate content of the PDA pitch may be within a range of from about 0.0 weight percent to about 1.0 weight percent. The saturate content of the PDA pitch may be less than about 1.0 weight percent, such as less than about 0.50 weight percent. An aromatic content of the PDA pitch may be within a range of from about 50.0 weight percent to about 70.0 weight percent, such as within a range of from about 50.0 weight percent to about 55.0 weight percent, from about 55.0 weight percent to about 60.0 weight percent, from about 60.0 weight percent to about 65.0 weight percent, or from about 65.0 weight percent to about 70.0 weight percent. An aromatic content of the PDA pitch may be higher than about 50.0 weight percent, such as higher than about 55.0 weight percent, higher than about 60.0 weight percent, or higher than about 65.0 weight percent.

A resin content of the PDA pitch may be within a range of from about 20.0 weight percent to about 35.0 weight percent, such as from about 20.0 weight percent to about 25.0 weight percent, from about 25.0 weight percent to about 30.0 weight percent, or from about 30.0 weight percent to about 35.0 weight percent. The resin content of the PDA pitch may be higher than about 20.0 weight percent, such as higher than about 25.0 weight percent, or higher than about 30.0 weight percent. An asphaltene content of the PDA pitch may be within a range of from about 10.0 weight percent toa about 15.0 weight percent. The asphaltene of the PDA pitch may be less than about 15.0 weight percent, such as less than about 10.0 weight percent.

The deasphalted oil 138 may include a mixture of paraffins, naphthenes, and aromatics. In some embodiments, the deasphalted oil 138 is substantially free of asphaltenes. A boiling point range of the deasphalted oil 138 may be from about 230° C. (about 446° F.) to about 480° C. (about 896° F.). In some embodiments, the deasphalted oil 138 includes a 10 percent recovered temperature within a range of from about 230° C. (about 446° F.) to about 290° C. (about) 554°, a 50 percent recovered temperature within a range of from about 345° C. (about 653° F.) to about 400° C. (about 752° F.), a 90 percent recovered temperature within a range of from about 455° C. (about 851° F.) to about 510° C. (about 955° F.), and an endpoint within a range of from about 510° C. (about 955° F.) to about 565° C. (about 1,049° F.).

The deasphalted oil 138 may be further processed in the system 100, such as in a catalytic cracker, a delayed coker, and/or used as a blending component. As described herein, in some embodiments, at least a portion of the deasphalted oil 138 is blended in an asphalt binder. The deasphalted oil 138 may exhibit a vacuum viscosity within a range of 10 cP to about 100 cP at about 100° C.

As described in additional detail herein with respect to FIG. 3 and FIG. 4, in some embodiments, one or more components formed within the system 100 may be used to form a base asphalt material. The base asphalt material may be mixed with the hard asphalt 140 to form a cracking resistant asphalt binder. The base asphalt material may include a neat asphalt that is substantially free of modifiers, polymers, or other additives. In some embodiments, the base asphalt material includes a straight asphalt obtained from the distillation of the crude oil 102 and comprises, consists essentially of, or consists of the vacuum tower bottoms material 134. The base asphalt material may include one or more of the vacuum tower bottoms material 134 (e.g., the second portion 142 of the vacuum tower bottoms material 134) and at least one of the heavy vacuum gas oil 132, the medium vacuum gas oil 130, the light vacuum gas oil 128, or the deasphalted oil 138. In some embodiments, the base asphalt material exhibits a performance grade of PG 58-28. The base asphalt material may include at least about 40.0 weight percent of the vacuum tower bottoms material 134, such as at least about 50.0 weight percent, or at least about 60.0 weight percent of the vacuum tower bottoms material 134.

The hard asphalt 140 may be added to the base asphalt material to form a cracking resistant asphalt binder exhibiting desired properties. The cracking resistant asphalt binder may include at least about 5.0 parts by weight of the hard asphalt 140 for every about 100.0 parts by weight of the base asphalt material. In some embodiments, the cracking resistant asphalt binder including the hard asphalt 140 and the base asphalt material exhibits a ΔT_{c} greater than −5° C. after aging for 20 hours or 40 hours in a PAV. The cracking resistant asphalt binder may have a performance grade of 64-22. In some embodiments, the m-value of the cracking resistant asphalt binder may be controlled by controlling the amount and type of the hard asphalt 140 in the cracking resistant asphalt binder.

FIG. 2 is a simplified schematic of a system 200 for forming (producing, generating) a hard asphalt 240 that may be used to blend with a base asphalt material (a base asphalt binder) to form a blended asphalt binder comprising a cracking resistant asphalt binder, according to at least one embodiment of the disclosure. The system 200 may be substantially similar to the system 100 described above with reference to FIG. 1, except that the system 200 may include more than one atmospheric distillation tower and more than one vacuum distillation tower.

The system 200 may include a first crude distillation unit 201 and a second crude distillation unit 203. The first crude distillation unit 201 and the second crude distillation unit 203 may be substantially similar to the crude distillation unit 101 described above with reference to FIG. 1. In some embodiments, the first crude distillation unit 201 and the second crude distillation unit 203 are configured to process different crude oils. For example, the first crude distillation unit 201 may be configured to process a first crude oil 202 and the second crude distillation unit 203 may be configured to process a second crude oil 205 having one or more different properties than the first crude oil 202.

The first crude oil 202 may exhibit a density less than a density of the second crude oil 205. In some embodiments, the first crude oil 202 is a low-density crude oil having an API gravity greater than about 40° or a medium-density crude oil having an API gravity between about 30° and about 40°; and the second crude oil 205 is a high-density crude oil having an API gravity less than about 30°. In some embodiments, a sulfur content of the first crude oil 202 is different than a sulfur content of the second crude oil 205. In some embodiments, the first crude oil 202 includes a lower sulfur content than the second crude oil 205.

With continued reference to FIG. 2, the first crude distillation unit 201 and the second crude distillation unit 203 may be substantially the same as the crude distillation unit 101 described above. Components of the first crude distillation unit 201 and the second crude distillation unit 203 that are the same as or similar to components of the crude distillation unit 101 described above with reference to FIG. 1 retain the same numerical designation. The first crude distillation unit 201 includes a first atmospheric distillation tower 106a and the second crude distillation unit 203 includes a second atmospheric distillation tower 106b. The first atmospheric distillation tower 106a and the second atmospheric distillation tower 106b may each be substantially the same as the atmospheric distillation tower 106 described above with reference to FIG. 1, but the first atmospheric distillation tower 106a and the second atmospheric distillation tower 106b may be configured to process crude oils 202, 205 having different properties. In some embodiments, the first atmospheric distillation tower 106a and the second atmospheric distillation tower 106b are configured to be operated at different conditions (e.g., temperature, pressure) than one another. In some embodiments, the second crude oil 205 is a heavier crude oil than the first crude oil 202, and the temperature of the second atmospheric distillation tower 106b is higher than the temperature of the first atmospheric distillation tower 106a.

In some embodiments, due to the different compositions of the first crude oil 202 and the second crude oil 205, the properties (e.g., the distillation points, the distillation curves, the flash points, the freeze points, the pour points, the vapor pressure, the density, the sulfur content, other properties) of the overhead gaseous material 108, the light naphtha material 110, the heavy naphtha material 112, the jet material 114, the diesel material 116, the atmospheric gas oil 118, and/or the atmospheric tower bottoms material 120 of the first atmospheric distillation tower 106a and the second atmospheric distillation tower 106b may be different from one another. In some embodiments, the first atmospheric distillation tower 106a forms a first atmospheric tower bottoms material 120a and the second atmospheric distillation tower 106b forms a second atmospheric tower bottoms material 120b having one or more different properties than the first atmospheric tower bottoms material 120a.

In some embodiments, the first atmospheric tower bottoms material 120a exhibits a lower density, lower distillation points (e.g., a lower 10 percent point, a lower 50 percent point, a lower 90 percent point, a lower endpoint), a lower flash point, and a lower sulfur content than the second atmospheric tower bottoms material 120b. In addition, in some embodiments, the second atmospheric tower bottoms material 120b may include a greater asphaltene content and a greater resin content than the first atmospheric tower bottoms material 120a. The first atmospheric tower bottoms material 120a may exhibit a higher paraffinic content than the second atmospheric tower bottoms material 120b.

In some embodiments, the second atmospheric tower bottoms material 120b exhibits a higher viscosity than the first atmospheric tower bottoms material 120a. A viscosity of the first atmospheric tower bottoms material 120a may be within a range of from about 100 cSt to about 1,000 cSt at about 100° C., and the viscosity of the second atmospheric tower bottoms material 120b may be greater than about 1,000 cSt at about 100° C.

With continued reference to FIG. 2, in some embodiments, the first crude distillation unit 201 includes a low vacuum distillation tower 124a that may be substantially the same as the vacuum distillation tower 124 (FIG. 1). The low vacuum distillation tower 124a may be operated at a pressure within a range of from about 50 mmHg absolute to about 100 mmHg absolute, such as from about 50 mmHg absolute to about 60 mmHg absolute, from about 60 mmHg absolute to about 70 mmHg absolute, from about 70 mmHg absolute to about 80 mmHg absolute, from about 80 mmHg absolute to about 90 mmHg absolute, or from about 90 mmHg absolute to about 100 mmHg absolute.

The low vacuum distillation tower 124a may be configured to receive the first atmospheric tower bottoms material 120a and form a first overhead vapor material 126a, a light vacuum gas oil 128, a first medium vacuum gas oil 130a, and a low viscosity vacuum tower bottoms material 234 (also referred to as a “low vacuum tower bottoms material” or a “light vacuum tower bottoms material”). The first overhead vapor material 126a, the light vacuum gas oil 128, and the first medium vacuum gas oil 130a may be substantially the same as those described above with reference to FIG. 1.

The low vacuum distillation tower 124a may be operated at conditions (e.g., temperature, pressure) to form the low viscosity vacuum tower bottoms material 234, which may be substantially the same as the low viscosity vacuum tower bottoms material described above with reference to FIG. 1 where the vacuum tower bottoms material 134 includes a low viscosity vacuum tower bottoms material. For example, the low viscosity vacuum tower bottoms material 234 may have a vacuum viscosity within a range of 1 P to about 200 P at about 60° C., an initial boiling point greater than about 566° C., a density within a range of from about 0.98 g/cm³ to about 1.10 g/cm³, a viscosity within a range of from about 50 cSt to about 500 cSt at about 100° C., a pour point within a range of from about 27° C. to about 65° C., and/or a flash point greater than about 149° C. In some embodiments, the low viscosity vacuum tower bottoms material 234 includes a bimodal distribution of C₆ to C₂₅ hydrocarbons and C₂₅ to C₃₅ hydrocarbons, as measured by TE GC-MS. The C₆ to C₂₅ hydrocarbons may be aliphatic and may be in the diesel range, and the C₂₅ to C₃₅ hydrocarbons may be aliphatic and may be in the vacuum gas oil range. As measured by PY-GCMS, the low viscosity vacuum tower bottoms may include C₄ to C₂₃ hydrocarbons, such as a mixture of C₄ to C₂₃ olefinic and paraffinic hydrocarbons. In some embodiments, the low viscosity vacuum tower bottoms material 234 further includes up to C₂₉ paraffins. The mixture of C₄ to C₂₃ olefinic and paraffinic hydrocarbons may include pairs of olefinic and paraffinic C₄ to C₂₃ hydrocarbons.

In some embodiments, at least a first portion 239 of the low viscosity vacuum tower bottoms material 234 may be further processed, such as in an asphalt processing system 236. In some embodiments, the low viscosity vacuum tower bottoms material 234 has a vacuum viscosity less than about 100 P at about 60° C., or a vacuum viscosity within a range of from about 100 P to about 200 P at about 60° C. The asphalt processing system 236 may be substantially similar to the asphalt processing system 136 (FIG. 1). In some embodiments, the asphalt processing system 236 is configured to generate a deasphalted oil 238 and a hard asphalt 240. The asphalt processing system 236 may include a solvent include propane, a mixture of n-butane and isobutane, or another solvent. In some embodiments, the solvent of the asphalt processing system 236 includes propane and the hard asphalt 240 includes PDA pitch. The PDA pitch may have substantially the same properties as that described above. In some embodiments, the solvent of the asphalt processing system 236 includes a mixture of n-butane and isobutane (e.g., butane comprises from about 11.0 weight percent to about 99.0 weight percent of the solvent and iso-butane comprises from about 1.0 weight percent to about 82.0 weight percent of the solvent) and the hard asphalt 240 includes SDA pitch. The SDA pitch may have the same properties as that described above. The SDA pitch may have a different composition and properties (e.g., viscosity, stiffness, softening point) than the PDA pitch.

A second portion 242 of the low viscosity vacuum tower bottoms material 234 may be further processed or blended elsewhere in the system 200. In some embodiments, the second portion 242 is blended as a component of a cracking resistant asphalt binder, is coked, and/or is catalytically cracked in the system 200.

With continued reference to FIG. 2, in some embodiments, the second crude distillation unit 203 includes a high vacuum distillation tower 124b, that may be substantially the same as the vacuum distillation tower 124 (FIG. 1) and operated at a pressure within a range of from about 5 mmHg absolute to about 50 mmHg absolute, such as from about 5 mmHg absolute to about 25 mmHg absolute, or from about 25 mmHg absolute to about 50 mmHg absolute. The pressure of the high vacuum distillation tower 124b may be within a range of from about 5 mmHg absolute to about 25 mmHg absolute, such as from about 5 mmHg absolute to about 10 mmHg absolute, from about 10 mmHg absolute to about 15 mmHg absolute, from about 15 mmHg absolute to about 20 mmHg absolute, or from about 20 mmHg absolute to about 25 mmHg absolute. Accordingly, the high vacuum distillation tower 124b may be operated at a lower pressure (a higher vacuum) than the low vacuum distillation tower 124a.

The high vacuum distillation tower 124b may be configured to receive the second atmospheric tower bottoms material 120b and form a second overhead vapor material 126b, a second medium vacuum gas oil 130b, a heavy vacuum gas oil 132, and a high viscosity vacuum tower bottoms material 250 (also referred to as a “high vacuum tower bottoms material”). The second overhead vapor material 126b, the second medium vacuum gas oil 130b, and the heavy vacuum gas oil 132 may be substantially the same as those described above with reference to FIG. 1.

The high vacuum distillation tower 124b may be operated at conditions to form the high viscosity vacuum tower bottoms material 250 (also referred to as a “heavy vacuum tower bottoms material” or a “high vacuum tower bottoms material”), which may be substantially the same as the high viscosity vacuum tower bottoms material described above. For example, the high viscosity vacuum tower bottoms material 250 has a vacuum viscosity within a range of from about 60,000 P to about 200,000 P at about 60° C., such as from about 60,000 P to about 100,000 P, from about 100,000 P to about 150,000 P, or from about 150,000 P to about 200,000 P at about 60° C. In some embodiments, the high viscosity vacuum tower bottoms material 250 has a viscosity greater than about 60,000 P, such as greater than about 100,000 P, or greater than about 150,000 P at about 60° C.

The high viscosity vacuum tower bottoms material 250 may exhibit a high temperature compliance within a range of from about 85° C. to about 95° C., such as from about 85° C. to about 87° C., from about 87° C. to about 90° C., from about 90° C. to about 92° C., or from about 92° C. to about 95° C. In some embodiments, the high temperature compliance of the high viscosity vacuum tower bottoms material 250 is within a range of from about 87° C. to about 95° C. The high temperature compliance of the high viscosity vacuum tower bottoms material 250 may be greater than about 87° C., such as greater than about 90° C., or greater than about 92° C.

A low temperature compliance of the high viscosity vacuum tower bottoms material 250 after PAV aging for 20 hours may be within a range of from about −9° C. to about 0° C., such as from about −9° C. to about −6° C., from about −6° C. to about −3° C., or from about −3° C. to about 0° C. The low temperature compliance of the high viscosity vacuum tower bottoms material 250 after PAV aging for 20 hours may be less than about 0° C., such as less than about −3° C., or less than about −6° C.

A ΔT_{c} of the high viscosity vacuum tower bottoms material 250 may be greater than about-5° C. In other words, a minimum ΔT_{c} of the high viscosity vacuum tower bottoms material 250 may be about −5° C. In some embodiments, the ΔT_{c} of the high viscosity vacuum tower bottoms material 250 after PAV aging for 20 hours or 40 hours is greater than about −5° C., such as greater than about −4° C., −2° C., or 0° C.

The composition of the high viscosity vacuum tower bottoms material 250 may be the same as that described above. For example, as measured by the IP 469 standard, in some embodiments, the high viscosity vacuum tower bottoms material includes from about 3.0 weight percent to about 5.0 weight percent saturates, from about 30.0 weight percent to about 45.0 weight percent aromatics, from about 29.0 weight percent to about 45.0 weight percent resins, and from about 21.0 weight percent to about 25.0 weight percent asphaltenes.

In some embodiments, one or more components of the system 200 may be blended with the hard asphalt 240 to form a cracking resistant asphalt binder. In some embodiments, the hard asphalt 240 may be mixed with a base asphalt material to form a cracking resistant asphalt binder having a ΔT_{c} greater than −5° C. after aging for 20 hours or 40 hours in a PAV. The cracking resistant asphalt binder may have a performance grade of 64-22. In some embodiments, the hard asphalt 240 and another hard asphalt (e.g., from another asphalt processing system) may be mixed with the base asphalt material to form the cracking resistant asphalt binder. In some embodiments, the hard asphalt 240 facilitates forming a cracking resistant asphalt binder having a performance grade of PG 64-22 and having a ΔT_{c} higher than −5° C. after 40-hour PAV aging, wherein the cracking resistant asphalt binder is formed from a base asphalt binder having a performance grade of PG 58-28 and/or from a base asphalt binder that has a ΔT_{c} lower than −5° C. after 40-hour PAV aging.

The base asphalt material may include one or more components formed within the system 200. In some embodiments, the base asphalt material includes a straight asphalt obtained from the distillation of the first crude oil 202 and/or the second crude oil 205. The base asphalt material may include one or more of the high viscosity vacuum tower bottoms material 250, the low viscosity vacuum tower bottoms material 234, the light vacuum gas oil 128, the first medium vacuum gas oil 130a, the second medium vacuum gas oil 130b, the heavy vacuum gas oil 132, or the deasphalted oil 238. In some embodiments, the base asphalt material includes the high viscosity vacuum tower bottoms material 250 and one or more of the low viscosity vacuum tower bottoms material 234, the light vacuum gas oil 128, the first medium vacuum gas oil 130a, the second medium vacuum gas oil 130b, the heavy vacuum gas oil 132, or the deasphalted oil 238. In some embodiments, the base asphalt material includes at least about 40.0 weight percent of the high viscosity vacuum tower bottoms material 250. The base asphalt material may exhibit a performance grade of PG 58-28.

FIG. 3 is a simplified flow diagram illustrating a system 300 for forming a cracking resistant asphalt binder 302, according to at least one embodiment of the disclosure. The cracking resistant asphalt binder 302 may be formed from a base asphalt material that is formed within the system 100 or the system 200. The cracking resistant asphalt binder 302 may be formed by mixing one or more hard asphalt materials with the base asphalt material. The one or more hard asphalts may be formed in the system 100 or the system 200, or may be provided to the cracking resistant asphalt binder 302 from elsewhere.

With reference to FIG. 3, different components of the cracking resistant asphalt binder 302 may be mixed together in-line (e.g., in-situ) and/or in a tank 304 or other storage vessel. In some embodiments, the cracking resistant asphalt binder 302 is mixed at a terminal. In some embodiments, the cracking resistant asphalt binder 302 is mixed in-line, wherein one or more components that form the cracking resistant asphalt binder 302 are directly mixed with another material to form the cracking resistant asphalt binder 302 without providing the one or more components to the tank 304. In other words, one or more components of the cracking resistant asphalt binder 302 may be directly mixed after processing in the system 100, 200. In some embodiments, one or more of the components used to form the cracking resistant asphalt binder 302 are stored in a tank and then provided to the cracking resistant asphalt binder 302 from the tank.

The cracking resistant asphalt binder 302 may be formed from a base asphalt material 306 (a base asphalt binder) and at least one hard asphalt, such as at least one of SDA pitch 308 or PDA pitch 310. In some embodiments, the cracking resistant asphalt binder 302 further includes at least one biomaterial 305. The base asphalt material 306 may include one or more of the vacuum tower bottoms material 134 (FIG. 1), the low viscosity vacuum tower bottoms material 234 (FIG. 2), the high viscosity vacuum tower bottoms material 250 (FIG. 2), or a combination thereof. In some embodiments, the base asphalt material 306 is formed from the system 100 (FIG. 1) and includes the vacuum tower bottoms material 134 and one or more of the heavy vacuum gas oil 132 (FIG. 1), the medium vacuum gas oil 130 (FIG. 1), the light vacuum gas oil 128 (FIG. 1), or the deasphalted oil 138 (FIG. 1). The base asphalt material 306 may have a performance grade of PG 58-28. The SDA pitch 308 and the PDA pitch 310 may be formed in the system 100, 200, or may be provided to the base asphalt material 306 from another location. In some embodiments, one of the SDA pitch 308 and the PDA pitch 310 is formed in the system 200, and the other of the SDA pitch 308 and the PDA pitch 310 is provided from another location. In some embodiments, the SDA pitch 308 is formed in the system 200 and the PDA pitch 310 is provided from another location.

In some embodiments, the base asphalt material 306 is formed from the system 200 (FIG. 2) and includes the high viscosity vacuum tower bottoms material 250 (FIG. 2) and one or more of the low viscosity vacuum tower bottoms material 234 (FIG. 2), the light vacuum gas oil 128 (FIG. 2), the first medium vacuum gas oil 130a (FIG. 2), the second medium vacuum gas oil 130b (FIG. 2), the heavy vacuum gas oil 132 (FIG. 2), or the deasphalted oil 238 (FIG. 2).

In some embodiments, the base asphalt material 306 includes, for example, from about 0.0 weight percent to about 22.0 weight percent of the heavy vacuum gas oil 132 (FIG. 1, FIG. 2); from about 0.0 weight percent to about 4.0 weight percent of a medium vacuum gas oil (the medium vacuum gas oil 130 (FIG. 1), the first medium vacuum gas oil 130a (FIG. 2), and/or the second medium vacuum gas oil 130b (FIG. 2)); from about 0.0 weight percent to about 4.0 weight percent of a low viscosity vacuum tower bottoms material (e.g., the low viscosity vacuum tower bottoms material 234 (FIG. 2)); from about 0.0 weight percent to about 1.0 weight percent of a deasphalted oil (e.g., the deasphalted oil 138 (FIG. 1), the deasphalted oil 238 (FIG. 2)); and from about 64.0 weight percent to about 95.0 weight percent of a high viscosity vacuum tower bottoms material (e.g., the high viscosity vacuum tower bottoms material 250 (FIG. 2)).

In some embodiments, the high viscosity vacuum tower bottoms material constitutes at least about 40.0 weight percent of the base asphalt material 306, such as at least about 45.0 weight percent, at least about 50.0 weight percent, at least about 55.0 weight percent, at least about 60.0 weight percent, at least about 65.0 weight percent, or even at least about 70.0 weight percent of the base asphalt material 306. In some embodiments, the high viscosity vacuum tower bottoms material constitutes at least about 60.0 weight percent of the base asphalt material 306, such as at least about 64.0 weight percent, at least about 70.0 weight percent, at least about 80.0 weight percent, or even at least about 90.0 weight percent of the base asphalt material 306.

The heavy vacuum gas oil 132 may constitute from about 0.0 weight percent to about 22.0 weight percent of the base asphalt material 306, such as from about 0.0 weight percent to about 5.0 weight percent, from about 5.0 weight percent to about 10.0 weight percent, from about 10.0 weight percent to about 15.0 weight percent, from about 15.0 weight percent to about 20.0 weight percent, or from about 20.0 weight percent to about 22.0 weight percent of the base asphalt material 306.

The medium vacuum gas oil may constitute from about 0.0 weight percent to about 4.0 weight percent of the base asphalt material 306, such as from about 0.0 weight percent to about 1.0 weight percent, from about 1.0 weight percent to about 2.0 weight percent, or from about 2.0 weight percent to about 4.0 weight percent of the base asphalt material 306.

The low viscosity vacuum tower bottoms material may constitute from about 0.0 weight percent to about 4.0 weight percent of the base asphalt material 306, such as from about 0.0 weight percent to about 1.0 weight percent, from about 1.0 weight percent to about 2.0 weight percent, or from about 2.0 weight percent to about 4.0 weight percent of the base asphalt material 306.

In some embodiments, the base asphalt material 306 comprises, consists essentially of, or consists of the high viscosity vacuum tower bottoms material 250. In some embodiments, the base asphalt material 306 includes the high viscosity vacuum tower bottoms material 250, the heavy vacuum gas oil 132, and the low viscosity vacuum tower bottoms material. In some embodiments, the base asphalt material 306 includes the high viscosity vacuum tower bottoms material 250 and each of the low viscosity vacuum tower bottoms material 234, the light vacuum gas oil 128, a medium vacuum gas oil 130a, 130b, and the heavy vacuum gas oil 132. The base asphalt material 306 may further include a deasphalted oil (e.g., the deasphalted oil 238).

In some embodiments, the base asphalt material 306 comprises a performance grade PG 58-22 asphalt binder. In some embodiments, the base asphalt material 306 has a ΔT_{c} after 40-hour PAV aging lower than −5° C. and mixing the PDA pitch 310 with the base asphalt material 306 forms a cracking resistant asphalt binder having a performance grade of PG 64-22 and a ΔT_{c} after 40-hour PAV aging higher than −5° C. The cracking resistant asphalt binder 302 may also have a high temperature compliance higher than the high temperature compliance of the base asphalt material 306. In some embodiments, mixing the SDA pitch 308 with a base asphalt binder having a performance grade of PG 58-28 facilitates forming a cracking resistant asphalt binder 302 having a performance grade of PG 64-22 and a ΔT_{c} after 40-hour PAV aging higher than −5° C. In some embodiments, the base asphalt material 306 has a positive ΔT_{c} after 40-hour PAV aging (e.g., higher than 0° C.). The base asphalt material 306 may have a positive ΔT_{c} after 40-hour PAV aging and a performance grade of PG 58-28.

In some embodiments, the cracking resistant asphalt binder 302 is formed from the base asphalt material 306 and SDA pitch 308. In some embodiments, the cracking resistant asphalt binder 302 is formed from the base asphalt material 306 and PDA pitch 310. In some embodiments, the cracking resistant asphalt binder 302 is formed from the base asphalt material 306, SDA pitch 308, and PDA pitch 310. In some such embodiments, the cracking resistant asphalt binder 302 includes the base asphalt material 306 and both of SDA pitch 308 and PDA pitch 310. In some embodiments, hard asphalt (the one of the SDA pitch 308 or the PDA pitch 310) constitutes at least about 5.0 weight percent of the cracking resistant asphalt binder 302.

The SDA pitch 308 may constitute from about 5.0 weight percent to about 20.0 weight percent of the cracking resistant asphalt binder 302 by weight of the base asphalt material 306, such as from about 5.0 weight percent to about 10.0 weight percent, from about 10.0 weight percent to about 15.0 weight percent, or from about 15.0 weight percent to about 20.0 weight percent of the cracking resistant asphalt binder 302 by weight of the base asphalt material 306. In other words, for every about 100.0 parts by weight of the base asphalt material 306, the cracking resistant asphalt binder 302 may include from about 5.0 parts by weight to about 20.0 parts by weight of the SDA pitch 308.

The PDA pitch 310 may constitute from about 5.0 weight percent to about 45.0 weight percent of the cracking resistant asphalt binder 302 by weight of the base asphalt material 306, such as from about 5.0 weight percent to about 15.0 weight percent, from about 15.0 weight percent to about 25.0 weight percent, from about 25.0 weight percent to about 35.0 weight percent, or from about 35.0 weight percent to about 45.0 weight percent of the cracking resistant asphalt binder 302 by weight of the base asphalt material 306. In some embodiments, the cracking resistant asphalt binder 302 includes at least about 15.0 parts by weight of the PDA pitch 310, such as at least about 20.0 parts by weight, at least about 25.0 parts by weight, at least about 30.0 parts by weight, at least about 35.0 parts by weight, at least about 40.0 parts by weight, or at least about 45.0 parts by weight of the PDA pitch 310 for every about 100.0 parts by weight of the base asphalt material 306.

The cracking resistant asphalt binder 302 including at least one of the SDA pitch 308 or the PDA pitch 310 may meet PG standards and may have a ΔT_{c} greater than about −5° C. after PAV aging for 20 hours or 40 hours. The use of the SDA pitch 308 and/or the PDA pitch 310 in the cracking resistant asphalt binder 302 may improve the properties of the cracking resistant asphalt binder 302, while also providing a commercial value for the hard asphalt. For example, the SDA pitch 308 and/or the PDA pitch 310 may exhibit synergistic properties with the base asphalt binder 302. The addition of the SDA pitch 308 and/or the PDA pitch 310 having the properties described herein to the base asphalt binder may improve both the high temperature properties (such as the high temperature compliance) and the low temperature properties (such as the ΔT_{c} after aging) of the base asphalt material 306. In some embodiments, due to the addition of the SDA pitch 308 and/or the PDA pitch 310 to the base asphalt material 306, the cracking resistant asphalt binder 302 may have a higher (less negative) ΔT_{c} after 20 hour and after 40-hour PAV aging, even though SDA pitch 308 and/or the PDA pitch 310 has a vacuum viscosity at about 60° C. higher than the vacuum viscosity of the base asphalt binder 302. In addition, the SDA pitch 308 and/or the PDA pitch 310, when added to the base asphalt material 306, may improve the high temperature compliance of the base asphalt material 306 such that the cracking resistant asphalt binder 302 exhibits a higher high temperature compliance than the base asphalt material 306.

As described above, in some embodiments, the cracking resistant asphalt binder 302 further includes at least one biomaterial 305. The biomaterial 305 may include one or more materials formed from naturally-occurring materials, such as one or more materials formed from one or more vegetable oils and/or derived from one or more vegetable oils. In some embodiments, the biomaterial 305 includes at least 80.0 weight percent resin material, as determined by a SARA analysis. The biomaterial 305 may include a bio-resin. In some embodiments, the biomaterial 305 comprises a vegetable resin, such as a material including more than about 80.0 weight percent resins derived from one or more vegetable oils. A resin content of the biomaterial 305 may be at least about 80.0 weight percent, such as at least about 85.0 weight percent, at least about 90.0 weight percent, at least about 95.0 weight percent, at least about 97.0 weight percent, at least about 98.0 weight percent, at least about 99.0 weight percent, or at least about 99.5 weight percent resin. In some embodiments, resins constitute greater than about 90.0 weight percent of the biomaterial 305. In some embodiments, during a SARA analysis, more than about 80.0 weight percent of the biomaterial 305 is a resin. In other words, more than about 80.0 weight percent of the biomaterial 305 is soluble in a polar solvent, such as dichloromethane (DCM) or acetone.

In some embodiments, the biomaterial 305 includes at least some asphaltenes. Asphaltenes, if present in the biomaterial 305, may constitute from about 1.0 weight percent to about 20.0 weight percent of the biomaterial 305, such as from about 1.0 weight percent to about 2.0 weight percent, from about 2.0 weight percent to about 3.0 weight percent, from about 3.0 weight percent to about 4.0 weight percent, from about 4.0 weight percent to about 6.0 weight percent, from about 6.0 weight percent to about 8.0 weight percent, from about 8.0 weight percent to about 10.0 weight percent, or from about 10.0 weight percent to about 20.0 weight percent of the biomaterial 305. In some embodiments, asphaltenes constitute at least about 2.0 weight percent of the biomaterial 305, such as at least about 3.0 weight percent, at least about 5.0 weight percent, or at least about 7.0 weight percent of the biomaterial 305. In some embodiments, the biomaterial 305 comprises, consists essentially of, or consists of resins and asphaltenes. In some such embodiments, the biomaterial 305 is free of (e.g., substantially free of) saturates and aromatics.

The biomaterial 305 may include less than about 10.0 weight percent aromatics. Aromatics may constitute less than about 20.0 weight percent of the biomaterial 305, such as less than about 15.0 weight percent, less than about 10.0 weight percent, less than about 5.0 weight percent, or less than about 2.0 weight percent of the biomaterial 305. Aromatics, if present in the biomaterial 305, may constitute from about 1.0 weight percent to about 10.0 weight percent of the biomaterial 305, such as from about 1.0 weight percent to about 5.0 weight percent, or from about 5.0 weight percent to about 10.0 weight percent of the biomaterial 305. The biomaterial 305 may include less than about 5.0 weight percent of saturates, such as less than about 4.0 weight percent, or less than about 2.5 weight percent saturates. Saturates, if present in the biomaterial 305, may constitute from about 0.10 weight percent to about 3.0 weight percent of the biomaterial 305, such as from about 0.10 weight percent to about 1.0 weight percent, from about 1.0 weight percent to about 2.0 weight percent, or from about 2.0 weight percent to about 3.0 weight percent of the biomaterial 305. In some embodiments, the biomaterial 305 is substantially free of saturates. In some embodiments, the biomaterial 305 is substantially free of aromatics. In some embodiments, the biomaterial 305 is substantially free of saturates and aromatics and consists essentially of resins and asphaltenes. In some embodiments, the biomaterial 305 consists essentially of resins.

In some embodiments, the biomaterial 305 includes a bio-resin and includes a thermoplastic material. In some embodiments, the bio-resin is a resin derived from a renewable biological source material, such as plants, animals, algae, and microorganisms. In some embodiments, the biomaterial 305 is a polymer-based bio-resin. In some embodiments, the bio-resin includes a mixture of terpenes (e.g., one or more of alpha-pinene, beta-pinene, delta-3 carene, sabinene, limonene, terpinolene, sesquiterpenes, longifolene, caryophyllene, and delta-cadinene) and resin acids. In some embodiments, the biomaterial 305 includes alpha-pinene, beta-pinene, delta-3 carene monocyclic terpenes (e.g., limonene, terpinolene), sesquiterpenes (e.g., longifolene and caryophyllene), or combinations thereof. The biomaterial 305 may further include one or more rosin acids, such as one or more of abietic acid, pimaric acid, neoabietic acid, palustric acid, isopimaric acid, or combinations thereof.

In some embodiments, the biomaterial 305 includes a bio-resin that is formed from (e.g., derived from) one or bio-oils. The bio-oil may include one or more of vegetable oils, animal oils, or oil from algae (e.g., green algae (e.g., hallucinophyta, sea cucumber, parasites, hearing, beard hearing, jadebug, and salt weekly), brown algae (e.g., seaweed, kelp), red algae (e.g., red sea bream, red sea bream, red sea bream, red sea bream, red sea bream)). In some embodiments, the biomaterial 305 includes a bio-resin formed from one or more triglyceride-based vegetable oils. In some embodiments, the vegetable oil includes a triglyceride (which may be molecule comprising a reaction product of glycerol and three fatty acids, each of which fatty acids may be the same or different, and each of which fatty acids may be saturated or unsaturated). In some embodiments, the bio-oil is formed from biomass waste, such as by pyrolysis of biomass. In some embodiments, the bio-oil includes pyrolysis oil, which may be biomass-derived pyrolysis oil, municipal-waste derived pyrolysis oil, and/or pyrolysis oil formed from vegetable oils, animal fats, algae oil, or other biological material.

In some embodiments, the biomaterial 305 includes a bio-oil, such as vegetable oil, and/or the biomaterial 305 is derived from a vegetable oil. Non-limiting examples of vegetable oils include canola oil, safflower oil, flaxseed oil, cottonseed oil, peanut oil, almond oil, rice oil, linseed oil, rapeseed oil, jatropha oil, rubber seed oil, sunflower oil, soybean oil, olive oil, palm oil, castor coil, corn oil, grapeseed oil, jojoba oil, sesame oil, walnut oil, hazelnut oil, shea butter oil, macadamia oil, alfalfa oil, coconut oil, oiticica oil, poppyseed oil, soya oil, tung oil, algae oil, and wheat germ oil. In some embodiments, the biomaterial 305 includes bio-oil, such as animal oil and/or the biomaterial 305 is derived from animal oil. Non-limiting examples of animal oils include tallow oil (e.g., beef tallow oil), lard, or fish oil.

The algae oil may be formed from unicellular and/or multicellular algae. The algae oil may be formed from rhodophytes, chlorophytes, heterokontophytes, tribophytes, glaucophytes, chlorarachniophytes, euglenoids, haptophytes, cryptomonads, dinoflagellums, phytoplanktons, and combinations thereof. Non-limiting examples of species of algae include, for example, Neochloris oleoabundans, Scenedesmus dimorphus, Euglena gracilis, Phaeodactylum tricornutum, Pleurochrysis carterae, Prymnesium parvum, Tetraselmis chuff, and Chlamydomonas reinhardtii. Additional, non-limiting examples of algae species include one or more microalgae of the Achnanthes, Amphiprora, Amphora, Ankistrodesmus, Asteromonas, Boekelovia, Borodinella, Botryococcus, Bracteococcus, Chaetoceros, Carteria, Chlamydomonas, Chlorococcum, Chlorogonium, Chlorella, Chroomonas, Chrysosphaera, Cricosphaera, Crypthecodinium, Cryptomonas, Cyclotella, Dunaliella, Ellipsoidon, Emiliania, Eremosphaera, Ernodesmius, Euglena, Franceia, Fragilaria, Gloeothamnion, Haematococcus, Halocafeteria, Hymenomonas, Isochrysis, Lepocinclis, Micractinium, Monoraphidium, Nannochloris, Nannochloropsis, Navicula, Neochloris, Nephrochloris, Nephroselmis, Nitzschia, Ochromonas, Oedogonium, Oocystis, Ostreococcus, Pavlova, Parachlorella, Pascheria, Phaeodactylum, Phagus, Platymonas, Pleurochrysis, Pleurococcus, Prototheca, Pseudochlorella, Pyramimonas, Pyrobotrys, Scenedesmus, Skeletonema, Spyrogyra, Stichococcus, Tetraselmis, Thalassiosira, Viridiella, and Volvox species, and/or one or more cyanobacteria of the Agmenellum, Anabaena, Anabaenopsis, Anacystis, Aphanizomenon, Arthrospira, Asterocapsa, Borzia, Calothrix, Chamaesiphon, Chlorogloeopsis, Chroococcidiopsis, Chroococcus, Crinalium, Cyanobacterium, Cyanobium, Cyanocystis, Cyanospira, Cyanothece, Cylindrospermopsis, Cylindrospermum, Dactyl ococcopsis, Dermocarpella, Fischerella, Fremyella, Geitleria, Geitlerinema, Gloeobacter, Gloeocapsa, Gloeothece, Halospirulina, Iyengariella, Leptolyngbya, Limnothrix, Lyngbya, Microcoleus, Microcystis, Myxosarcina, Nodularia, Nostoc, Nostochopsis, Oscillatoria, Phormidium, Planktothrix, Pleurocapsa, Prochlorococcus, Prochloron, Prochlorothrix, Pseudanabaena, Rivularia, Schizothrix, Scytonema, Spirulina, Stanieria, Starria, Stigonema, Symploca, Synechococcus, Synechocystis, Tolypothrix, Trichodesmium, Tychonema, and Xenococcus species.

In some embodiments, biomaterial 305 includes a bio-oil including one or more fatty acids. For example, each of the vegetable oils, animal oils, and/or algae oils described above may include one or more fatty acids (e.g., may include monoglycerides, diglycerides, and/or triglycerides formed from one or more fatty acids). Accordingly, the biomaterial 305 formed from the bio-oils may include one or more corresponding fatty acids and/or comprise a reaction product of one or more fatty acids or materials containing the one or more fatty acids.

The fatty acids may be unsaturated fatty acids and one or more saturated fatty acids. The unsaturated fatty acids and the saturated fatty acids may be naturally occurring (e.g., derived from plants, such as from vegetable oils and/or algae oils; and/or derived from animal sources). The fatty acids may be linear, branched, or may include one or more cyclic groups. The unsaturated fatty acids may include a monounsaturated fatty acid having one carbon to carbon double bond; a di-unsaturated fatty acid having two carbon to carbon double bonds; a tri-unsaturated fatty acid having three carbon to carbon double bonds; a tetra-unsaturated fatty acid having four carbon to carbon double bonds; a penta-unsaturated fatty acid having five carbon to carbon double bonds; a hexa-unsaturated fatty acid having six carbon to carbon double bonds; or a polyunsaturated fatty acid having more than six carbon to carbon double bonds. In some embodiments, the wetting agent includes one or more monounsaturated fatty acids, one or more di-unsaturated fatty acids, and one or more tri-unsaturated fatty acids.

The unsaturated fatty acid may include one or more of linolenic acid (e.g., α-linolenic acid and/or γ-linolenic acid), stearidonic acid, eicosapentaenoic acid, cervonic acid, linoleic acid, linolelaidic acid, arachidonic acid, docosatetranoic acid, palmitoleic acid, vaccenic acid, paullinic acid, oleic acid, elaidic acid, erucic acid, crotonic acid, myristoleic acid, sapienic acid, gadoleic acid, or eicosenoic acid.

The saturated fatty acids may include one or more of valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, behenic acid, tricosylic acid, lignoceric acid, pentacosylic acid, cerotic acid, carboceric acid, montanic acid, nonacosylic acid, melissic acid, lacceroic acid, or psyllic acid. In some embodiments, the saturated fatty acids include C₁₆ and/or C₁₈ saturated fatty acids. For example, the saturated fatty acids may include one or both of palmitic acid and stearic acid. In some embodiments, the saturated fatty acids include C₁₂ fatty acids, such as lauric acid. In some embodiments, the saturated fatty acids include linear saturated fatty acids and may be naturally occurring, such as saturated fatty acids sourced from plants (e.g., vegetable oils) and/or animals.

In some embodiments, the unsaturated fatty acid includes one or more unsaturated C₁₈ fatty acids, such as one or more of oleic acid, linoleic acid, linolelaidic acid, α-linolenic acid, γ-linolenic acid, or stearidonic acid. In some embodiments, the biomaterial 305 is formed from unsaturated fatty acids and/or material including unsaturated fatty acids including each of oleic acid, linoleic acid, and α-linolenic acid; and saturated fatty acids including one or both of stearic acid and palmitic acid. In some embodiments, the biomaterial 305 is formed from elaidic acid and/or materials including elaidic acid. In some embodiments, the fatty acids include one or more C₁₈ fatty acids, such as one or more of stearic acid, oleic acid, linoleic acid, and linolenic acid. In some embodiments, the fatty acids include palmitic acid and/or myristic acid.

Bio-resins formed from such bio-oils and/or materials including the fatty acids described above may include one or more of a phenolic resin, an epoxy resin, a polyester resin, an alkyd resin, and/or a polyurethane resin formed from the bio-oil. The phenolic resin, epoxy resin, polyester resin, alkyd resin, and polyurethane resin may include one or more fatty acids therein. For example, such resins may include a backbone including components of the fatty acids. By way of non-limiting example, a fatty acid may have the general formula R—COOH, wherein R is the base of the fatty acid (e.g., oleic acid may have the formula R—COOH, wherein R is CH₃(CH₂)₇CH—CH—(CH₂)₇—. In other words, the R group of the fatty acid may be incorporated in the biomaterial 305 and/or at least a portion of the R group of the fatty acid may be incorporated in the biomaterial 305.

In some embodiments, the bio-resin is formed from a bio-oil, such as a vegetable oil, animal oil, or a combination thereof. The bio-resins may include bio-resins formed from such bio-oils and may include phenolic resins, epoxy resins, polyester or alkyd resins, polyurethane resins, polyamine resins, or combinations thereof. In other words, the biomaterial may include a bio-oil-based phenolic resin, a bio-oil-based epoxy resin, a bio-oil-based polyester resin, a bio-oil-based alkyl resin, a bio-oil-based polyurethane resin, a bio-oil-based polyamine resin, or combinations thereof. The bio-oil may include one or more vegetable oils and the bio-oil based phenolic resin may include a vegetable-based phenolic resin; the bio-oil-based epoxy resin may include a vegetable-based epoxy resin; the bio-oil-based polyester may include a vegetable-based polyester; the bio-oil-based alkyl resin may include a vegetable-based alkyl resin; the bio-oil-based polyurethane resin may include a vegetable-based polyurethane resin; and the bio-oil-based polyamine resin may include a vegetable-based polyamine resin.

By way of non-limiting example, bio-oil-based phenolic resins may be formed by reacting phenols present in the bio-oil and/or in a pyrolysis oil derived from a biological material (e.g., biomass-derived pyrolysis oil, municipal-waste derived pyrolysis oil, and/or pyrolysis oil formed from vegetable oils, animal fats, algae oil, or other biological material), with an aldehyde (e.g., formaldehyde) to form phenol-aldehyde resins (e.g., phenol-formaldehyde resins). In some embodiments, the phenolic fraction of the bio-oil may be extracted from the bio-oil prior to reaction with the aldehyde. In some such embodiments, the biomaterial 305 includes a phenolic resin comprising a reaction product of the bio-oil and an aldehyde, such as formaldehyde. In some embodiments, the bio-oils are formed from or derived from pyrolysis of lignocellulosic materials. In some embodiments, vegetable oils may be thermally cracked or pyrolyzed to form phenol-containing materials that may be reacted with an aldehyde to form the phenolic resin. In some embodiments, the biomaterial 305 includes a bio-based phenolic resin comprising a reaction product of the pyrolysis oil derived from a biological material and an aldehyde. The reaction between the pyrolysis oil derived from the biological material and the aldehyde may be an aldol condensation reaction to form the bio-oil-based phenolic resins.

Epoxy-resins formed from bio-oil may be formed by epoxidizing the bio-oils, such as by reacting the bio-oil with one or more of epichlorohydrin, glycidol (epoxy alcohol), glycerol derivatives, propylene oxide, oxytane, ethylene oxide, diallyl carbonate, maleic anhydride, or other reactive agents to form an epoxidized bio-oil. In some embodiments, the bio-resin includes a reaction product of an epoxidized vegetable oil and a diamine, such as a diamine derived from one or more fatty acid dimers (e.g., fatty diamines). In some embodiments, the bio-oil includes an unsaturated bio-oil (e.g., one or more unsaturated fatty acids). The unsaturated bio-oil may be reacted with an oxidizing agent (e.g., hydrogen peroxide, epichlorohydrin) to epoxidize the bio-oil. The epoxidized bio-oil may be polymerized and/or cross-linked to form an epoxy-resin. The crosslinkers may include, for example, an anhydride (phthalic anhydride, maleic anhydride), an amine (e.g., ethylenediamine, diethylenetriamine), a polyol, and/or a phenolic compound. In some embodiments, the biomaterial 305 includes a reaction product of an epoxidized bio-oil and a crosslinker, such as one or more of an anhydride (phthalic anhydride, maleic anhydride), an amine (e.g., ethylenediamine, diethylenetriamine), a polyol, or a phenolic compound. Accordingly, in some embodiments, the biomaterial 305 comprises a bio-resin including one or more bio-oil-based epoxy-resins, which may be formed from one or more epoxidized bio-oils that have been polymerized and/or crosslinked. In some embodiments, the bio-resin includes a vegetable-based epoxy resin.

Polyester or alkyd resins may be formed by deriving fatty acids or esters from the bio-oils (e.g., through transesterification) and reacting with polyols (e.g., one or more of glycerol, pentaerythritol, or trimethylolpropane) and/or anhydrides (e.g., one or more of maleic anhydride, phthalic anhydride, isophthalic acid, glutaric anhydride, and/or succinic anhydride) to produce unsaturated polyester resins or alkyd resins. In some embodiments, the bio-oil and the polyol are mixed to form a mixture wherein the bio-oil is reacted with the polyol to at least partially esterify the bio-oil. The anhydrides may be added to the mixture, wherein the anhydrides react via condensation with the bio-oil and/or the polyol. Accordingly, the biomaterial 305 may include an alkyd resin comprising a reaction product of the bio-oil, a polyol, and an anhydride.

In some embodiments, the bio-oil may be reacted with a diol in a polycondensation reaction to form a polyester comprising a reaction product of the diol and the bio-oil. In some embodiments, the bio-oil is reacted with an alcohol (e.g., glycerol) to form a glyceride (e.g., monoglycerides, diglycerides), which is then reacted with an anhydride in a condensation reaction to form the alkyd resin. In some embodiments, the biomaterial 305 includes a vegetable-based polyester resin and/or a vegetable-based alkyd resin. In yet other embodiments, the polyester is formed via the fatty acid method, wherein the bio-oil is reacted with a polyhydric alcohol to form the polyester, wherein the polyester includes a backbone including the fatty acids of the bio-oil.

In some embodiments, the bio-oil or the biomaterial 305 do not include alkyd resins. In other words, the biomaterial 305 may be free of alkyd resins.

Polyurethane (PU) resins may be formed by hydroxylating bio-oils (such as by reacting the bio-oils with ethylene and/or diethylene glycol) to form a hydroxylated bio-oil; and reacting the hydroxylated bio-oil with isocyanates to produce bio-based polyurethanes. In some embodiments, the bio-oil is modified by epoxidation to form an epoxidized bio-oil, followed by hydroxylation to form polyols having a high hydroxyl number. The polyols may include polyols derived from bio-oils and may comprise a reaction product of an epoxidized bio-oil and one or both of water and an alcohol. The resulting polyols derived from the bio-oil is reacted with the isocyanate to form the bio-oil-based polyurethane resin. The isocyanate may include a diisocyanate, such as one or more of toluene diisocyanate, methylene diphenyl diisocyanate, naphthalene-1,5-diisocyanate, isophorone diisocyanate, hexamethylene diisocyanate, or methylene-4,4′-diphenyl diisocyanate. In some embodiments, the biomaterial 305 includes a vegetable-based polyurethane resin. In some embodiments, the biomaterial 305 includes a bio-oil-based polyurethane resin comprising a reaction product of a polyol derived from a bio-oil and an isocyanate.

The bio-oil-based polyamine resin may be formed by, for example, reacting a dimer acid with a diamine. In some embodiments, the bio-oil-based polyamine resin includes a reaction product of a dimer acid and a diamine. The diamine may include, for example, hexamethylene diamine. The dimer acid may be a dicarboxylic acid formed by the dimerization of an unsaturated fatty acid. In some embodiments, the dimer acid is formed by the condensation of oleic acid and includes C₃₆ dimer acid.

In some embodiments, the bio-oil-based polyamine resin includes a reaction product of an aminated oil and an epoxidized fatty acid and/or an epoxidized bio-oil. The aminated oil may include a reaction product of cysteamine chloride and one or both of a fatty diamine or a fatty amide. The fatty diamine or the fatty amide may include one or more of the fatty acids described above. In some embodiments, the bio-oil-based polyamine resin includes a reaction product of an epoxidized bio-oil and an amine. The amine may include, for example, one or more of ammonia, ethylenediamine, hexamethylenediamine, or other primary or secondary amines. In other embodiments, the bio-oil-based polyamine resin includes a reaction product of the bio-oil and an amine, which forms a bio-amide including amide bonds (e.g., R-COOH+NH2-R′→R—CONH—R′). The resulting bio-amide may be polymerized by reaction with an epoxide and/or an aldehyde (e.g., formaldehyde) and/or by polycondensation.

In some embodiments, the bio-resin includes a plant resin, such as one or more of amber resin, pine resin, Commiphora gileadensis (Balm of Gilead) resin, balsam, copal from trees of Protium copal and Hymenaea courbaril, dammar gum or dammar resin from trees of Dipterocarpaceae, resin from trees of plants of Calamus (Dracaena species) (also referred to as “dragon's blood”), elemi resin, olibanum (also referred to as frankincense) from Boswellia sacra, galbanum from Ferula gummosa, gum guaicum from the lignum vitae trees of Guaiacum genus, kauri gum from trees of Agathis australis, hashish (cannabis resin) from Cannabis indica, labdanum from a species of Cistus, mastic resin from the mastic tree Pistacia lentiscus, myrrh from shrubs of Commiphora, sandarac resin from Tetraclinis articulata, storax balsam, and spinifex resin.

In some embodiments, the biomaterial 305 includes an ester bottoms material including methyl esters. Ester bottoms may include a low value byproduct of vegetable oil, animal fat, and/or recycled greases refining to produce methyl ester, such as biodiesel. Ester bottoms materials currently have relatively low value and are currently marketed for animal feed, lubricants, or other industrial uses at a low price point. In some embodiments, the biomaterial 305 comprises, consists essentially of, or consists of the ester bottoms material.

As noted above, ester bottoms materials are formed as a by-product of biodiesel refining. For example, a feedstock containing vegetable oil and/or animal fat is reacted and refined. By way of non-limiting example, the feedstock may be dried (e.g., in a dryer) to remove moisture therefrom and form dry oil. The dry oil may be fed to a reactor, such as a three-stage continuous reactor wherein a catalyst (e.g., sodium ethoxide) and methanol are added to each stage. The methanol reacts with the feedstock to form reaction products, which may include at least methyl ester and glycerin. In some embodiments, the reaction mixture including the reactants and the reaction products includes less than about 1.0 weight percent monoglycerides and is substantially free of diglycerides and triglycerides. The glycerin may be removed from the reaction mixture (e.g., may settle out of the reaction mixture) and may be directed away from the reactors for further processing. Removal of the glycerin from the reaction mixture may leave an ester phase.

The ester phase may be distilled (e.g., in a single stage flash distillation tank (or drum)) to remove any remaining methanol. The ester phase may be washed to remove at least some of the glycerin, soap, methanol, and methoxide catalyst. The washed methyl esters may dried in an ester dryer under vacuum to remove additional methanol and water. Sodium methoxide may be added to the drier to convert glycerin and monoglycerides into diglycerides and triglycerides. The methyl esters leaving the ester dryer may be preheated and provided to an ester surge tank. The esters may be fed to a distillation tower to separate purified methyl esters from ester bottoms. For example, the purified methyl esters may exit the top of the distillation tower and the ester bottoms may exit the bottom of the distillation tower.

The ester bottoms material may include one or more of (e.g., each of) methyl esters, sodium soap, monoglycerides, diglycerides, triglycerides, or unsaponifiable materials. Thus, the ester bottoms material may include methyl esters, monoglycerides, diglycerides, triglycerides, sodium soaps produced from the addition of sodium methoxide (a catalyst in the biodiesel refining process), and unsaponifiable materials. The ester bottoms material may not be or contain glycerin or skimmed fatty acids. In some embodiments, unsaponifiable materials constitute up to about 10.0 weight percent of the ester bottoms material. In some embodiments, the unsaponifiable materials constitute at least 10.0 weight percent of the ester bottoms material. In some embodiments, the unsaponifiable materials constitute at least about 2.0 weight percent, such as at least about 4.0 weight percent, at least about 6.0 weight percent, at least about 8.0 weight percent, or even at least about 10.0 weight percent of the ester bottoms material. In some embodiments, the ester bottoms material exhibits a viscosity within a range of from about 10 cP to about 900 cP at about 64° C.

The ester bottoms material may include methyl esters, monoglycerides, diglycerides, and triglycerides. By way of non-limiting example, a methyl ester content of the ester bottoms material may be within a range of from about 5.0 weight percent to about 20.0 weight percent, such as from about 5.0 weight percent to about 10.0 weight percent, from about 10.0 weight percent to about 15.0 weight percent, or from about 15.0 weight percent to about 20.0 weight percent. In some embodiments, the methyl ester content of the ester bottoms material is within a range of from about 9.0 weight percent to about 14.0 weight percent.

A monoglyceride content of the ester bottoms material may be less than about 2.0 weight percent, such as less than about 1.0 weight percent, or less than about 0.75 weight percent. A diglyceride content of the ester bottoms material may be within a range of from about 5.0 weight percent to about 15.0 weight percent, such as from about 5.0 weight percent to about 7.0 weight percent, from about 7.0 weight percent to about 9.0 weight percent, from about 9.0 weight percent to about 11.0 weight percent, from about 11.0 weight percent to about 13.0 weight percent, or from about 13.0 weight percent to about 15.0 weight percent. In some embodiments, the diglyceride content of the ester bottoms material is within a range of from about 7.0 weight percent to about 11.0 weight percent. The diglyceride content of the ester bottoms material may be less than about 15.0 weight percent, such as less than about 13.0 weight percent, or less than about 11.0 weight percent of the ester bottoms material. A triglyceride content of the ester bottoms material maybe within a range of from about 37.0 weight percent 47.0 weight percent, such as from about 37.0 weight percent to about 39.0 weight percent, from about 39.0 weight percent to about 41.0 weight percent, from about 41.0 weight percent to about 43.0 weight percent, from about 43.0 weight percent to about 45.0 weight percent, or from about 45.0 weight percent to about 47.0 weight percent of the ester bottoms material. In some embodiments, the triglyceride content of the ester bottoms material is greater than about 40.0 weight percent and/or is within a range of from about 40.0 weight percent to about 43.0 weight percent.

A weight percent of either diglycerides or triglycerides in the ester bottoms material (in addition to the diglyceride content and the triglyceride content described above) may be within a range of 20.0 weight percent to about 30.0 weight percent, such as from about 20.0 weight percent to about 25.0 weight percent, or from about 25.0 weight percent to about 30.0 weight percent. A total fatty acid content of the ester bottoms material (not including the monoglycerides, diglycerides, triglycerides, or combination of diglycerides and triglycerides) may be less than about 5.0 weight percent, such as within a range of from about 1.0 weight percent to about 5.0 weight percent, such as from about 2.0 weight percent to about 4.0 weight percent.

An aromatic content of the ester bottoms material may be within a range of from about 5.0 weight percent to about 10.0 weight percent, such as from about 5.0 weight percent to about 7.0 weight percent, from about 7.0 weight percent to about 9.0 weight percent, or from about 9.0 weight percent to about 11.0 weight percent. In some embodiments, aromatics constitute from about 7.5 weight percent to about 8.5 weight percent of the ester bottoms material. A resin content of the ester bottoms material may be within a range of from about 85.0 weight percent to about 95.0 weight percent, such as from about 85.0 weight percent to about 87.5 weight percent, from about 87.5 weight percent to about 90.0 weight percent, from about 90.0 weight percent to about 92.5 weight percent, or from about 92.5 weight percent to about 95.0 weight percent. In some embodiments, resins constitute from about 91.5 weight percent to about 92.5 weight percent of the ester bottoms material. In some embodiments, the aromatic content of the ester bottoms material is greater than the aromatic content of the other biomaterials 305 described herein.

Table 1 below shows the composition of three different ester bottoms materials, as measured by gas chromatography-mass spectrometry (GC-MS).

TABLE 1

| Component | Sample 1 | Sample 2 | Sample 3 |
|---|---|---|---|
| Total methyl ester | 12.853 | 9.113 | 13.322 |
| Total fatty acids | 2.901 | 2.376 | 2.906 |
| Total monoglycerides | 0.506 | 0.628 | 0.678 |
| Total diglycerides | 7.577 | 10.670 | 8.970 |
| Total triglycerides | 42.214 | 41.847 | 40.450 |
| Unknown between | 22.958 | 24.001 | 21.677 |
| diglycerides or triglycerides | | | |
| Other unknowns | 10.991 | 11.366 | 11.997 |

The biomaterial 305 may have a specific gravity within a range of from about 0.80 to about 0.90, such as from about 0.80 to about 0.82, from about 0.82 to about 0.84, from about 0.84 to about 0.86, from about 0.86 to about 0.88, or from about 0.88 to about 0.90. In some embodiments, the biomaterial 305 has a specific gravity within a range of from about 0.82 to about 0.86, such as from about 0.83 to about 0.85. A viscosity of the biomaterial 305 at about 64° C. may be within a range of from about 10 cP to about 1,000 cP, such as from about 10 cP to about 50 cP, from about 50 cP to about 100 cP, from about 100 cP to about 300 cP, from about 300 cP to about 500 cP, from about 500 cP to about 750 cP, or from about 750 cP to about 1,000 cP. In some embodiments, the viscosity of the biomaterial 305 at about 64° C. is within a range of from about 10 cP to about 900 cP. A boiling point of the biomaterial 305 may be higher than about 200° C.

In some embodiments, the biomaterial 305 includes at least two different biomaterials. For example, the biomaterial 305 may include a first material including a vegetable oil, plant oil, and/or a bio-resin derived from vegetable oil and/or animal oils; and a second material including an ester bottoms material. By way of non-limiting example, the biomaterial 305 may include a first material including at least 80.0 weight percent resin material, as determined by a SARA analysis; and a second material comprising the ester bottoms material.

The biomaterial 305 may constitute from about 0.50 weight percent to about 20.0 weight percent of the cracking resistant asphalt binder 302. The biomaterial 305 may constitute from about from about 0.50 weight percent to about 20.0 weight percent of the cracking resistant asphalt binder 302, such as from about 0.50 weight percent to about 1.0 weight percent, from about 1.0 weight percent to about 2.0 weight percent, from about 2.0 weight percent to about 4.0 weight percent, from about 4.0 weight percent to about 6.0 weight percent, from about 6.0 weight percent to about 8.0 weight percent, from about 8.0 weight percent to about 10.0 weight percent, from about 10.0 weight percent to about 12.0 weight percent, from about 12.0 weight percent to about 15.0 weight percent, or from about 15.0 weight percent to about 20.0 weight percent of the cracking resistant asphalt binder 302. In some embodiments, the biomaterial 305 constitutes from about 0.50 weight percent to about 12.0 weight percent of the cracking resistant asphalt binder 302. In some such embodiments, the cracking resistant asphalt binder 302 includes from about 0.50 part by weight to about 12.0 parts by weight to the biomaterial 305 for every about 100.0 parts by weight of the cracking resistant asphalt binder 302. The biomaterial 305 may constitute greater than about 2.0 weight percent, such as greater than about 4.0 weight percent, greater than about 6.0 weight percent, greater than about 8.0 weight percent, greater than about 10.0 weight percent, or even greater than about 12.0 weight percent of the cracking resistant asphalt binder 302.

In embodiments where the biomaterial 305 includes a first biomaterial and a second biomaterial, each of the first biomaterial and the second biomaterial may be present in a weight percent of from about 0.50 weight percent to about 20.0 weight percent of the cracking resistant asphalt binder 302; or the combined weight percent of the first biomaterial and the second biomaterial may be within a range of from about 0.50 weight percent to about 20.0 weight percent. In some embodiments, the biomaterial 305 includes the first biomaterial and the second biomaterial and includes a greater weight percent of the ester bottoms material than of the other biomaterial.

In some embodiments, the combination of the biomaterial 305 and one or both of the SDA pitch 308 and the PDA pitch 310 facilitates forming the cracking resistant asphalt binder 302 having desired properties. The biomaterial 305 may restore or maintain a desired composition of the cracking resistant asphalt binder 302, such as by providing a higher resin content than other components of the cracking resistant asphalt binder 302 and improving the low temperature compliance of the cracking resistant asphalt binder 302. At the same time, the SDA pitch 308 and the PDA pitch 310 may improve high temperature compliance of the cracking resistant asphalt binder 302 while also improving the ΔT_{c} after 40-hour PAV aging and/or while still meeting the ΔT_{c} after 40-hour PAV aging specification of higher than −5° C.

FIG. 4 is a simplified flow diagram illustrating a system 400 for forming a cracking resistant asphalt binder 402, according to at least one embodiment of the disclosure. The cracking resistant asphalt binder 402 may be formed by mixing one or more hard asphalts with one or more base asphalt materials.

In some embodiments, the cracking resistant asphalt binder 402 is formed from a base asphalt material 404 (a base asphalt binder). The base asphalt material 404 may be formed in the system 100 (FIG. 1) and/or the system 200 (FIG. 2). In some embodiments, the base asphalt material 404 is formed from one or more of a medium vacuum gas oil 408, a heavy vacuum gas oil 410, a high viscosity vacuum tower bottoms material 412, or a low viscosity vacuum tower bottoms material 414. The medium vacuum gas oil 408 may be substantially the same as the second medium vacuum gas oil 130b (FIG. 2); the heavy vacuum gas oil 410 may be substantially the same as the heavy vacuum gas oil 132 (FIG. 1, FIG. 2); the high viscosity vacuum tower bottoms material 412 may be substantially the same as the high viscosity vacuum tower bottoms material 250 (FIG. 2); and the low viscosity vacuum tower bottoms material 414 may be substantially the same as the low viscosity vacuum tower bottoms material 234 (FIG. 2).

In some embodiments, the low viscosity vacuum tower bottoms material 414 is formed within a first crude distillation unit 416, such as the first crude distillation unit 201 (FIG. 2). In some embodiments, the low viscosity vacuum tower bottoms material 414 is formed within the low vacuum distillation tower 124a (FIG. 2). Each of the medium vacuum gas oil 408, the heavy vacuum gas oil 410, and the high viscosity vacuum tower bottoms material 412 may be formed within a second crude distillation unit 418, such as the second crude distillation unit 203 (FIG. 2). In some embodiments, the medium vacuum gas oil 408, the heavy vacuum gas oil 410, and the high viscosity vacuum tower bottoms material 412 are formed in the high vacuum distillation tower 124b (FIG. 2).

Accordingly, the base asphalt material 404 may include one or more of the medium vacuum gas oil 408, heavy vacuum gas oil 410, the high viscosity vacuum tower bottoms material 412, and the low viscosity vacuum tower bottoms material 414. In some embodiments, the base asphalt material 404 includes the high viscosity vacuum tower bottoms material 412 and may further include one or more of the medium vacuum gas oil 408, heavy vacuum gas oil 410, or the low viscosity vacuum tower bottoms material 414.

In some embodiments, the high viscosity vacuum tower bottoms material 412 constitutes at least about 40.0 weight percent of the base asphalt material 404, such as at least about 45.0 weight percent, at least about 50.0 weight percent, at least about 55.0 weight percent, at least about 60.0 weight percent, at least about 65.0 weight percent, or even at least about 70.0 weight percent of the base asphalt material 404. In some embodiments, the high viscosity vacuum tower bottoms material constitutes at least about 60.0 weight percent of the base asphalt material 306, such as at least about 64.0 weight percent, at least about 70.0 weight percent, at least about 80.0 weight percent, or even at least about 90.0 weight percent of the base asphalt material 306.

The heavy vacuum gas oil 410 may constitute from about 0.0 weight percent to about 22.0 weight percent of the base asphalt material 306, such as from about 0.0 weight percent to about 5.0 weight percent, from about 5.0 weight percent to about 10.0 weight percent, from about 10.0 weight percent to about 15.0 weight percent, from about 15.0 weight percent to about 20.0 weight percent, or from about 20.0 weight percent to about 22.0 weight percent of the base asphalt material 404.

The medium vacuum gas oil 408 may constitute from about 0.0 weight percent to about 4.0 weight percent of the base asphalt material 306, such as from about 0.0 weight percent to about 1.0 weight percent, from about 1.0 weight percent to about 2.0 weight percent, or from about 2.0 weight percent to about 4.0 weight percent of the base asphalt material 404.

The low viscosity vacuum tower bottoms material 414 may constitute from about 0.0 weight percent to about 4.0 weight percent of the base asphalt material 306, such as from about 0.0 weight percent to about 1.0 weight percent, from about 1.0 weight percent to about 2.0 weight percent, or from about 2.0 weight percent to about 4.0 weight percent of the base asphalt material 404.

With continued reference to FIG. 4, at least one of an SDA pitch 420 or a PDA pitch 422 may be mixed with the base asphalt material 404 to form the cracking resistant asphalt binder 402. The SDA pitch 420 and the PDA pitch 422 may be the same as those described above. The SDA pitch 420 and the PDA pitch 422 may be formed in different asphalt processing systems.

In some embodiments, the cracking resistant asphalt binder 402 includes only one of the SDA pitch 420 or the PDA pitch 422. In some embodiments, the cracking resistant asphalt binder 402 includes only the SDA pitch 420. In some embodiments, the SDA pitch 420 constitutes from about 5.0 weight percent to about 20.0 weight percent of the cracking resistant asphalt binder 402 by weight of the base asphalt material 404, such as from about 5.0 weight percent to about 10.0 weight percent, from about 10.0 weight percent to about 15.0 weight percent, or from about 15.0 weight percent to about 20.0 weight percent of the cracking resistant asphalt binder 402 by weight of the base asphalt material 404. In some embodiments, adding the SDA pitch 420 to the base asphalt material 404 facilitates forming a cracking resistant asphalt binder 402 having a performance grade 64-22 from a base asphalt material 404 having a performance grade 58-28 while also meeting the 40-hour PAV aging ΔT_{c} requirement of higher than −5° C. In other words, even though the cracking resistant asphalt binder 402 includes a relatively high weight percent of the SDA pitch 420, the cracking resistant asphalt binder 402 may have a ΔT_{c} higher than −5° C. after 40-hour PAV aging; and the SDA pitch 420 may facilitate forming a PG 64-22 cracking resistant asphalt binder 402 from a PG 58-28 base asphalt material 404.

The PDA pitch 422 may constitute from about 5.0 weight percent to about 45.0 weight percent of the cracking resistant asphalt binder 402 by weight of the base asphalt material 404, such as from about 5.0 weight percent to about 15.0 weight percent, from about 15.0 weight percent to about 25.0 weight percent, from about 25.0 weight percent to about 35.0 weight percent, or from about 35.0 weight percent to about 45.0 weight percent of the cracking resistant asphalt binder 402 by weight of the base asphalt material 404.

The cracking resistant asphalt binder 402 including at least one of the SDA pitch 420 or the PDA pitch 422 may meet PG standards and may have a ΔT_{c} greater than about −5° C. after PAV aging for 20 hours or 40 hours. The use of the SDA pitch 420 or the PDA pitch 422 in the cracking resistant asphalt binder 402 may improve the properties of the cracking resistant asphalt binder 402.

In some embodiments, each of the components of the cracking resistant asphalt binder 402 (e.g., each of the high viscosity vacuum tower bottoms material 412, the heavy vacuum gas oil 410, the medium vacuum gas oil 408, the low viscosity vacuum tower bottoms material 414, the SDA pitch 420, and the PDA pitch 422) may be mixed in-line to form the cracking resistant asphalt binder 402. The cracking resistant asphalt binder 402 may be stored in a tank and/or may be provided to a terminal or other location. In some embodiments, the base asphalt material 404 may be formed in the first crude distillation unit 416 and/or the second crude distillation unit 418. The first crude distillation unit 416 and/or the second crude distillation unit 418 may not continuously produce a performance grade asphalt binder, such as an asphalt binder meeting a 40-hour PAV aging ΔT_{c} requirement (e.g., a 40-hour PAV aging ΔT_{c} higher than −5° C.) due to the varying composition and properties of the crude oils provided; and/or the first crude distillation unit 416 and/or the second crude distillation unit 418 may not form an asphalt binder having a desired performance grade. Mixing the SDA pitch 420 and/or the PDA pitch 422 with the base asphalt material 404 facilitates forming a performance grade cracking resistant asphalt binder 402 meeting such requirements. In some embodiments, mixing the SDA pitch 420 facilitates forming a performance grade 64-22 cracking resistant asphalt binder from a base asphalt binder having a performance grade of 58-22.

In some embodiments, the cracking resistant asphalt binder 402 may further include a biomaterial 405. The biomaterial 405 may be the same as that described above with reference to the biomaterial 305.

The cracking resistant asphalt binder 302, 402 may exhibit one or more desirable properties. In some embodiments, even though the cracking resistant asphalt binder 302, 402 includes more than at least about 5.0 weight percent of a hard asphalt, the cracking resistant asphalt binder 302, 402 is a performance grade asphalt binder. The cracking resistant asphalt binder 302, 402 may be a thermal cracking resistant asphalt binder and may exhibit a 40-hour PAV aged ΔT_{c} greater than −5° C.

The cracking resistant asphalt binder 302, 402 may exhibit a high temperature compliance greater than about 58° C., such as greater than about 64° C., greater than about 66° C., greater than about 68° C., or greater than about 70° C. Without being bound by any particular theory, it is believed that the presence of the hard asphalt (e.g., at least one of SDA pitch or PDA pitch) in the cracking resistant asphalt binder 302, 402 facilitates an increase in the high temperature compliance of the cracking resistant asphalt binder 302, 402 compared to the high temperature compliance of the base asphalt material. In some embodiments, the hard asphalt increases the high temperature compliance of the base asphalt material by at least about 2° C., at least about 4° C., at least about 6° C., or even at least about 8° C.

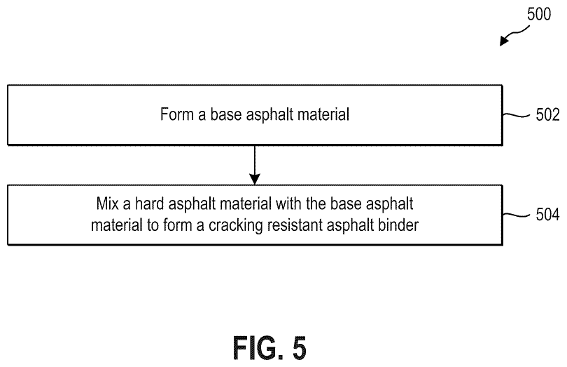

FIG. 5 is a simplified flow diagram illustrating a method 500 of forming a cracking resistant asphalt binder, according to at least one embodiment of the disclosure. The method 500 may include forming a base asphalt material, as shown in act 502. The base asphalt material may be substantially the same as the base asphalt material 306, 404. The base asphalt material may be formed in the system 100 (FIG. 1) and/or the system 200 (FIG. 2). In some embodiments, the base asphalt material includes a high viscosity vacuum tower bottoms material and at least one of a heavy vacuum gas oil, a medium vacuum gas oil, a low viscosity vacuum tower bottoms material, or a deasphalted oil.

The method 500 may further include mixing a hard asphalt with the base asphalt material to form a cracking resistant asphalt binder, as shown in act 504. The hard asphalt may include, for example, one or more of the SDA pitch 308 (FIG. 3), the PDA pitch 310 (FIG. 3), the SDA pitch 420 (FIG. 3), or the PDA pitch 422 (FIG. 3). In some embodiments, an amount of the hard asphalt added to the base asphalt material is sufficient such that hard asphalt constitutes from about 5.0 weight percent to about 45.0 weight percent of the cracking resistant asphalt binder, as described above.

### EXAMPLES

### Example 1

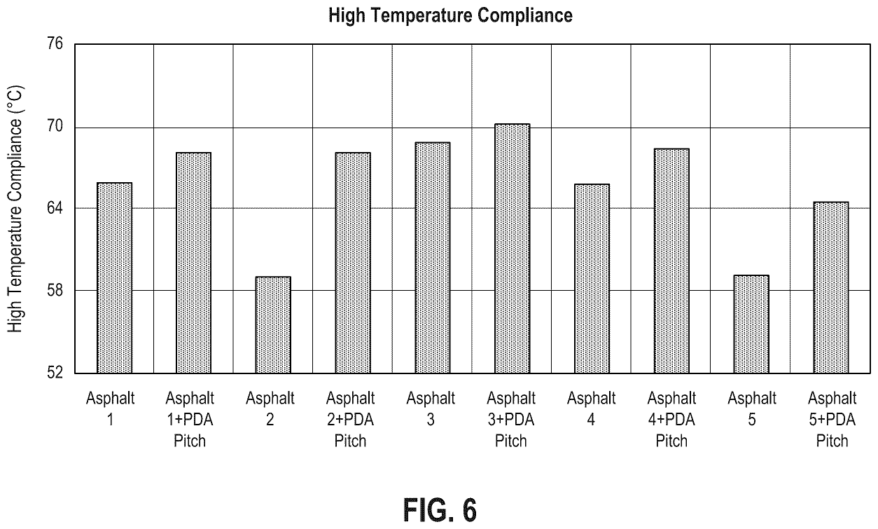

Propane deasphalting pitch was mixed with different base asphalt materials to form different cracking resistant asphalt binders. The high temperature compliance and the ΔT_{c} after PAV aging for 40 hours of the cracking resistant asphalt binders was compared to the high temperature compliance and the ΔT_{c} after PAV aging for 40 hours of the base asphalt materials to determine the effect of the propane deasphalting asphalt on the base asphalt materials. In FIG. 6, Asphalt 1, Asphalt 3, and Asphalt 4 were performance grade PG 64-22 asphalt binders; and Asphalt 2 and Asphalt 5 were performance grade PG 58-28 asphalt binders. The cracking resistant asphalt binders included between 15.0 weight percent to 30.0 weight percent propane deasphalting pitch by weight of the base asphalt material. In FIG. 6, the amount of propane deasphalting pitch added to each of Asphalt 1, Asphalt 3, and Asphalt 4 was about 15.0 weight percent such that the asphalt 1+PDA pitch, Asphalt 3+PDA pitch, and Asphalt 4+PDA pitch each included 15.0 weight percent of the propane deasphalting pitch by weight of the base asphalt binder; and the amount of propane deasphalting pitch added to each of Asphalt 2 and Asphalt 5 was about 30.0 weight percent such that Asphalt 2+PDA pitch and Asphalt 5+PDA pitch each included 30.0 weight percent of the propane deasphalting pitch by weight of the base asphalt binder.

FIG. 6 is a graph illustrating the high temperature compliance of the base asphalt materials (Asphalt 1, Asphalt 2, Asphalt 3, Asphalt 4, Asphalt 5) to the high temperature compliance of the cracking resistant asphalt binders including the propane deasphalting pitch. With reference to FIG. 6, the addition of the propane deasphalting pitch increased the high temperature compliance of each base asphalt material by at least about 1° C. In some instances, the propane deasphalting pitch increased the high temperature compliance of the base asphalt material by about 5° C. (asphalt 5), or even about 9° C. (asphalt 2). The addition of the PDA pitch changed the high temperature compliance Asphalt 2 and Asphalt 5 to be higher than 64° C. and facilitated forming a performance grade PG 64-22 asphalt binder from the performance grade PG 58-22 base asphalt material.

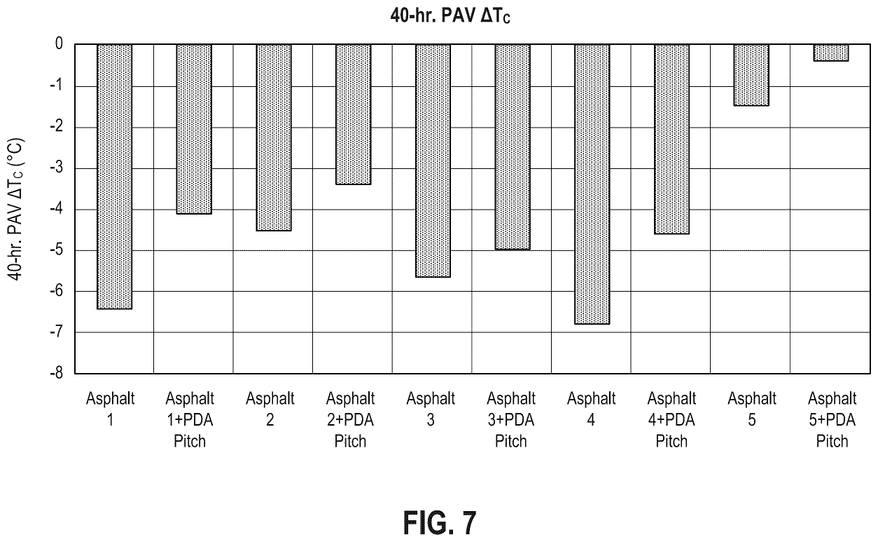

FIG. 7 is a graph illustrating the effect of the propane deasphalting pitch on the ΔT_{c} after PAV aging for 40 hours for each of the base asphalt materials. With reference to FIG. 7, Asphalt 1, Asphalt 3, and Asphalt 4 each failed to meet the requirement that the ΔT_{c} after PAV aging for 40 hours be −5° C. or higher (i.e., the ΔT_{c} after 40 PAV aging of Asphalt 1, Asphalt 3, and Asphalt 4 were lower (more negative) than −5° C. The addition of the propane deasphalting pitch to Asphalt 1, Asphalt 3, and Asphalt 4 increased the ΔT_{c} after PAV aging for 40 hours of the resulting cracking resistant asphalt binders. For example, the addition of the propane deasphalting pitch increased the ΔT_{c} after PAV aging for 40 hours of Asphalt 1 and Asphalt 4 by over 2° C. The addition of propane deasphalting pitch to each of the base asphalt materials increased the ΔT_{c} after PAV aging for 40 hours of each of the base asphalt materials. Accordingly, the addition of the PDA pitch facilitated increasing the 40-hour PAV aging ΔT_{c} to be higher than −5° C. and forming a performance grade PG 64-22 asphalt binder from performance grade base asphalt binders from PG 58-28 while also meeting low temperature requirements of 40-hour PAV aging ΔT_{c} to be higher than −5° C.; and/or increasing the 40-hour PAV aging ΔT_{c} of a performance grade base asphalt binder of PG 64-22 that does not meet low temperature requirements of a ΔT_{c} higher than −5° C. after 40-hour PAV aging such that the asphalt binder including the PDA pitch and the base asphalt binder has a ΔT_{c} higher than −5° C. after 40-hour PAV aging.

### Example 2

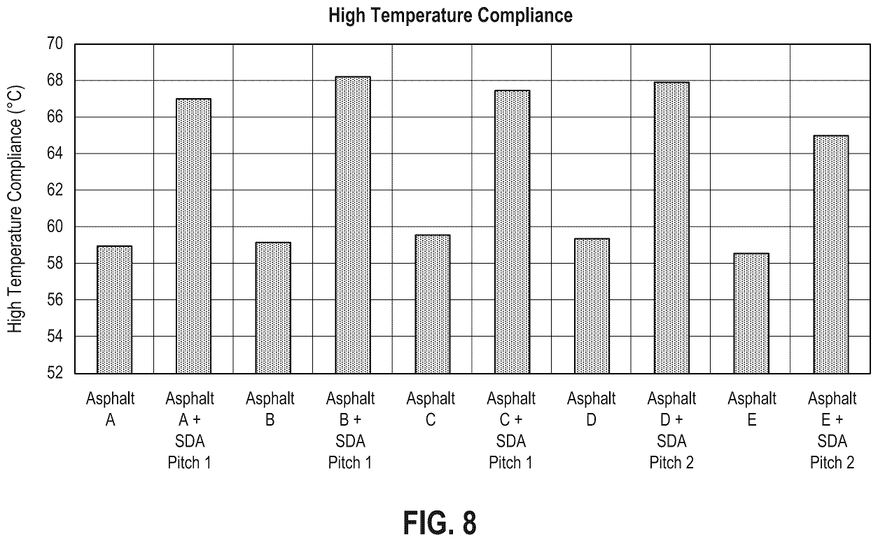

Solvent deasphalting pitch was mixed with different base asphalt materials to form different cracking resistant asphalt binders. The high temperature compliance and the ΔT_{c} after PAV aging for 40 hours of the cracking resistant asphalt binders was compared to the high temperature compliance and the ΔT_{c} after PAV aging for 40 hours of the base asphalt materials to determine the effect of the solvent deasphalting pitch on the base asphalt materials. The cracking resistant asphalt binders included between 5.0 weight percent to 20.0 weight percent solvent deasphalting pitch by weight of the base asphalt material. In FIG. 8, the base asphalt materials (Asphalt A, Asphalt B, Asphalt C, Asphalt D, and Asphalt E) were performance grade PG 58-28 asphalt binders. SDA Pitch 1 and SDA Pitch 2 were solvent deasphalting pitch hard asphalts, but were formed in different refineries and exhibited different properties. The amount of SDA Pitch 1 added to each of Asphalt A, Asphalt B, and Asphalt C range from between about 14.0 weight percent to about 15.0 weight percent by weight of the base asphalt binder. The amount of SDA Pitch 2 added to Asphalt D was about 10.0 weight percent by weight of the base asphalt binder, and the amount of SDA Pitch 2 added to Asphalt E was about 15.0 weight percent by weight of the base asphalt binder.

FIG. 8 is a graph illustrating the high temperature compliance of the base asphalt materials (Asphalt A, Asphalt B, Asphalt C, Asphalt D, Asphalt E) to the high temperature compliance of the cracking resistant asphalt binders including solvent deasphalting pitch. With reference to FIG. 8, the addition of the solvent deasphalting pitch increased the high temperature compliance of each base asphalt material by at least about 5° C. Accordingly, the addition of the solvent deasphalting pitch to each of the base asphalt materials formed a PG 64-22 asphalt binder from a PG 58-28 base asphalt material.

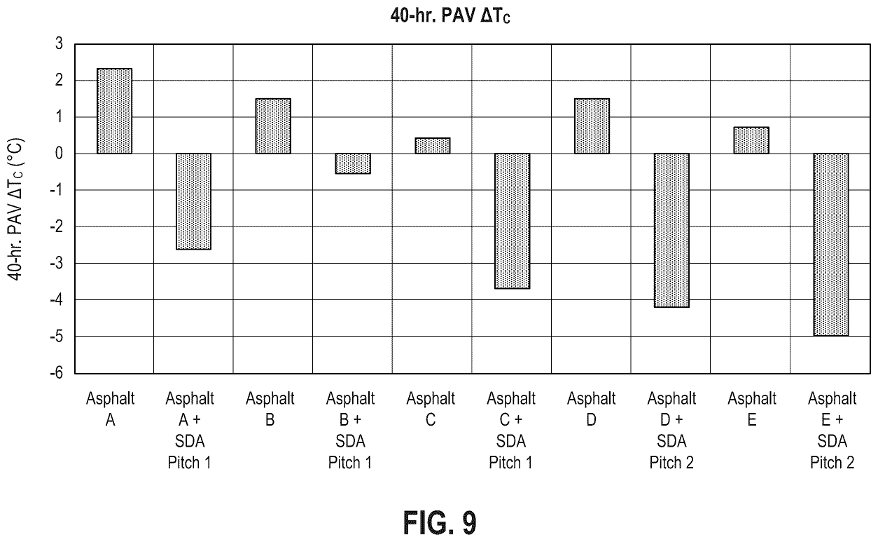

FIG. 9 is a graph illustrating the effect of the solvent deasphalting pitch on the ΔT_{c} after PAV aging for 40 hours for each of the base asphalt materials. With reference to FIG. 9, the addition of the solvent deasphalting pitch to each of the base asphalt materials lowered the ΔT_{c} after PAV aging for 40 hours of each of the base asphalt materials, but the ΔT_{c} after PAV aging for 40 hours remained higher than about −5° C. Accordingly, the addition of the solvent deasphalting pitch improved the high temperature compliance of the base asphalt materials without decreasing the ΔT_{c} after PAV aging for 40 hours of each of the base asphalt binders lower than −5° C. Surprisingly, the addition of the SDA pitch to the base asphalt materials formed a cracking resistant asphalt binder having a performance grade PG 64-22 from base asphalt binders having a performance grade of PG 58-22, while meeting the low temperature specifications of a ΔT_{c} higher than −5° C. after 40-hour PAV aging. It was surprising that the addition of at least 10.0 weight percent of the SDA pitch did not lower the 40-hour PAV aged a ΔT_{c} to be less than −5° C., but changed the performance grade of the asphalt binder from PG 58-28 to PG 64-22.

### Example 3

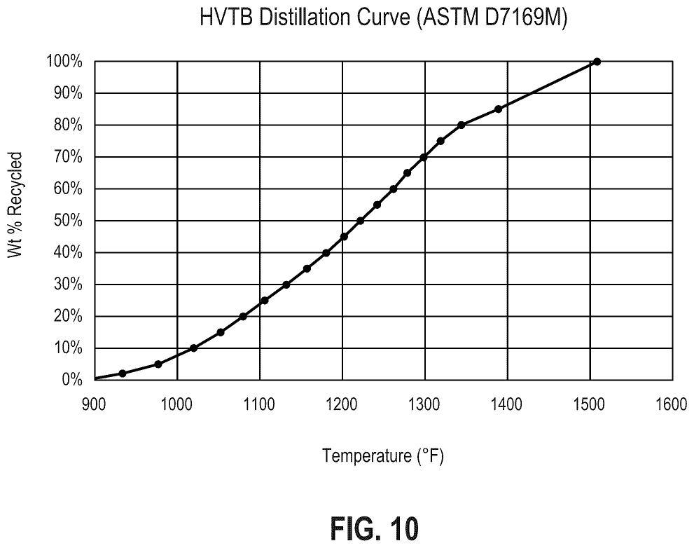

The distillation curve of a high viscosity vacuum tower bottoms material was measured according to the ASTM D7169M method. The weight percent of the high viscosity vacuum tower bottoms material that evaporated (was boiled off) as a function of temperature was measured. FIG. 10 is a graph illustrating the distillation curve of the high viscosity vacuum tower bottoms material. With reference to FIG. 10, the initial boiling point of the high viscosity vacuum tower bottoms material was about 482.2° C. (about 900° F.) and the end point of the high viscosity vacuum tower bottoms material was about 820° C. (about 1,508° F.).

### Example 4

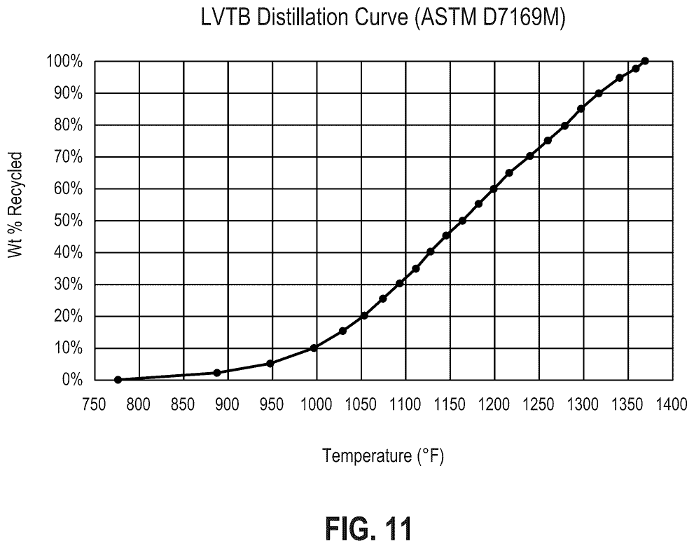

The distillation curve of a low viscosity vacuum tower bottoms material was measured according to the ASTM D7169M method. The weight percent of the low viscosity vacuum tower bottoms material that evaporated (was boiled off) as a function of temperature was measured. FIG. 11 is a graph illustrating the distillation curve of the low viscosity vacuum tower bottoms material. With reference to FIG. 11, the initial boiling point of the low viscosity vacuum tower bottoms material was about 410° C. (about 770° F.) and the end point of the low viscosity vacuum tower bottoms material was about 740.6° C. (about 1,365° F.).

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of forming a cracking resistant asphalt binder using at least one hard asphalt, the method comprising:
providing at least one hard asphalt comprising at least one of solvent deasphalting pitch or propane deasphalting pitch having a penetration between 0 dmm and 10 dmm at about 25° C., a softening point between about 65.6° C. and about 104.4° C., a high temperature compliance of at least about 85° C., and a low temperature compliance greater than about −12° C.; and
mixing the at least one hard asphalt with a base asphalt material to form a cracking resistant asphalt binder having a performance grade of PG 64-22 and a ΔT_{c} greater than −5° C. after PAV aging for 40 hours, the cracking resistant asphalt binder comprising at least about 5.0 weight percent of the at least one hard asphalt by weight of the base asphalt material.

2. The method of claim 1, wherein mixing the at least one hard asphalt with a base asphalt material comprises forming a cracking resistant asphalt binder having a higher ΔT_{c} after PAV aging for 40 hours than the base asphalt material.

3. The method of claim 1, wherein the hard asphalt has a penetration less than about 5 dmm at about 25° C.

4. The method of claim 1, wherein the at least one hard asphalt comprises solvent deasphalting asphalt having a viscosity greater than about 1,000,000 P at about 60° C.

5. The method of claim 1, wherein the at least one hard asphalt comprises solvent deasphalting pitch and propane deasphalting pitch.

6. The method of claim 1, wherein mixing the at least one hard asphalt with a base asphalt material to form a cracking resistant asphalt binder comprises forming the cracking resistant asphalt binder to comprise greater than about 15.0 weight percent solvent deasphalting pitch by weight of the base asphalt material.

7. The method of claim 1, wherein the at least one hard asphalt comprises solvent deasphalting pitch comprising:
from 0.8 weight percent to about 3.8 weight percent saturates;
from about 24.0 weight percent to about 41.6 weight percent aromatics;
from about 25.6 weight percent to about 37.7 weight percent resins; and
from about 16.8 weight percent to about 25.6 weight percent asphaltenes.

8. The method of claim 1, wherein the at least one hard asphalt comprises propane deasphalting pitch comprising:
from 0.0 weight percent to about 1.0 weight percent saturates;
from about 60.0 weight percent to about 70.0 weight percent aromatics;
from about 20.0 weight percent to about 30.0 weight percent resins; and
from about 10.0 weight percent to about 15.0 weight percent asphaltenes.

9. The method of claim 1, wherein the cracking resistant asphalt binder comprises greater than about 20.0 weight percent propane deasphalting pitch having a colloidal index from about 0.09 to about 0.20.

10. The method of claim 1, wherein providing at least one hard asphalt comprises:
forming a first atmospheric tower bottoms material in a first atmospheric distillation tower;
forming a second atmospheric tower bottoms material in a second atmospheric distillation tower;
distilling the first atmospheric tower bottoms material in a low vacuum distillation tower to form a low vacuum tower bottoms material;
distilling the second atmospheric tower bottoms material in a high vacuum distillation tower to form a high vacuum tower bottoms material having a higher viscosity than the low vacuum tower bottoms material;
contacting the low vacuum tower bottoms material with a solvent to form a pitch comprising one of propane deasphalting pitch or solvent deasphalting pitch; and
mixing the pitch with the base asphalt material.

11. The method of claim 1, wherein the base asphalt material comprises a neat asphalt free of additives and has a performance grade of PG 58-28.

12. The method of claim 1, wherein the base asphalt material comprises a heavy vacuum tower bottoms material having a vacuum viscosity greater than about 60,000 P at about 60° C., the heavy vacuum tower bottoms material constituting greater than about 60.0 weight percent of the base asphalt material.

13. A cracking resistant asphalt binder, comprising:
a base asphalt material having a performance grade of 58-28; and
at least about 5.0 parts by weight of a hard asphalt comprising at least one of solvent deasphalting asphalt or propane deasphalting asphalt for every about 100.0 parts by weight of the base asphalt material, the at least one of the solvent deasphalting asphalt or the propane deasphalting asphalt having a penetration between 0 dmm and 10 dmm at about 25° C., a softening point between about 65.6° C. and about 104.4° C., a high temperature compliance of at least about 85° C., and a low temperature compliance greater than about −12° C., wherein the cracking resistant asphalt binder has a performance grade of PG 64-22 and a ΔT_{c} greater than −5° C. after PAV aging for 40 hours.

14. The cracking resistant asphalt binder of claim 13, wherein the cracking resistant asphalt binder comprises at least 15.0 parts by weight of propane deasphalting pitch for every about 100.0 parts by weight of the base asphalt material, the propane deasphalting pitch including:
from 0.0 weight percent to about 1.0 weight percent saturates;
from about 60.0 weight percent to about 70.0 weight percent aromatics;
from about 20.0 weight percent to about 30.0 weight percent resins; and
from about 10.0 weight percent to about 15.0 weight percent asphaltenes.

15. The cracking resistant asphalt binder of claim 13, wherein the cracking resistant asphalt binder comprises at least 10.0 parts by weight solvent deasphalting pitch for every about 100.0 parts by weight of the base asphalt material.

16. The cracking resistant asphalt binder of claim 13, wherein the base asphalt material comprises a high viscosity vacuum tower bottoms material having a vacuum viscosity greater than about 60,000 P at about 60° C., a high temperature compliance of at least about 85° C., and a low temperature compliance between about 0° C. and about −9° C. after PAV aging for 20 hours, the high viscosity vacuum tower bottoms material constituting greater than about 60.0 weight percent of the base asphalt material.

17. The cracking resistant asphalt binder of claim 13, wherein the hard asphalt has a vacuum viscosity at least about 1,000,000 P at about 60° C.

18. The cracking resistant asphalt binder of claim 13, wherein the hard asphalt has a penetration between 0 dmm and 10 dmm at about 25° C., a softening point between about 65.6° C. and about 104.4° C., and a low temperature compliance greater than about −12° C.

19. A method of forming a cracking resistant asphalt binder using at least one hard asphalt, the method comprising:
providing a hard asphalt comprising at least one of solvent deasphalting asphalt or propane deasphalting asphalt, the hard asphalt having a vacuum viscosity of at least about 1,000,000 P at about 60° C. and a high temperature compliance of at least about 85° C.; and
mixing the at least one hard asphalt with a base asphalt material to form a cracking resistant asphalt binder having a ΔT_{c} greater than −5° C. after PAV aging for 40 hours, the cracking resistant asphalt binder comprising at least about 5.0 weight percent of the at least one hard asphalt by weight of the base asphalt material.

20. The method of claim 19, wherein:
the base asphalt material comprises a high viscosity vacuum tower bottoms material having a vacuum viscosity between about 60,000 P and about 200,000 P, the base asphalt material having a performance grade of 58-28; and
the hard asphalt has a penetration between 0 dmm and 10 dmm at about 25° C., a softening point between about 65.6° C. and about 104.4° C., and a low temperature compliance greater than about −12° C.
